(19) United States
(12) Patent Application Publication
(10) Pub. No.: US 2025/0247468 A1
(43) Pub. Date: Jul. 31, 2025

(54) AUTOMATED ALARM INTAKE AND CLASSIFICATION

(71) Applicant: RAPIDSOS, INC., New York, NY (US)

(72) Inventors: Conor Fucci, Brooklyn, NY (US); James Patrick Olejar, JR., Fort Lauderdale, FL (US); John Robert Katt, New York, NY (US); John Michael DiDonato, Pittsburgh, PA (US); Zvika Ferentz, Harrison, NY (US)

(21) Appl. No.: 18/621,074

(22) Filed: Mar. 28, 2024

Related U.S. Application Data
(60) Provisional application No. 63/625,487, filed on Jan. 26, 2024.

(51) Int. Cl. H04M 3/51; H04M 3/523; H04M 11/04

(52) U.S. Cl. CPC H04M 3/5116; H04M 3/5166; H04M 3/5235; H04M 11/04; H04M 2201/38; H04M 2201/40

(57) ABSTRACT

An emergency management system (EMS) captures alarm reports that are called into an emergency call center (ECC) and converts the audio data of the alarm report into actionable alert data that may be displayed in and dispatched from an emergency response application that is operated at the ECC. The alert system includes a central station system, an ECC system, and an emergency management system (EMS). The ECC system has call handling equipment (CHE) to receive calls for an emergency call telephone number and an alarm reporting telephone number. The emergency response application can display a queue of alerts, and each of the alerts includes alert data that can be displayed. The EMS includes an automated interview system that can at least partially use an AI model to transform the audio data into alert data that is used to populate the queue of alerts.

### CROSS-REFERENCE TO RELATED APPLICATIONS

This application claims priority to U.S. Provisional Application No. 63/625,487 filed Jan. 26, 2024, which is hereby incorporated by reference.

### TECHNICAL FIELD

This disclosure relates generally to emergency call center notifications, and in particular to improving data exchanges for an emergency call center.

### BACKGROUND

In commercial and residential alarm systems, some sort of input (e.g., a sensor) triggers an alarm signal that gets sent to a centralized monitoring agency or station. The monitoring agency is typically a privately owned organization that handles the verification of the alarms. These commercial and residential alarm systems may include various types of alarms (e.g., residential fire alarms, home security alarms, commercial fire alarms, bank teller alarms, and the like). If the alarm appears to be legitimate, the monitoring agency contacts a public emergency services agency. A public emergency services agency may also be referred to as an emergency communications center (ECC) or public safety answering point (PSAP).

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A illustrates diagrams of an electronic device and an emergency management system (EMS), in accordance with embodiments of the disclosure.

FIG. 1B illustrates diagrams of an emergency service provider (ESP) system and ESP software, in accordance with embodiments of the disclosure.

FIG. 1C illustrates diagrams of a central station system and a central station application, in accordance with embodiments of the disclosure.

FIG. 2 illustrates a diagram of a clearinghouse that may be used by an EMS, in accordance with embodiments of the disclosure.

FIGS. 3A and 3B illustrate diagrams of emergency response environments, in accordance with embodiments of the disclosure.

FIGS. 4A and 4B illustrate diagrams of 10-digit line alert systems, in accordance with embodiments of the disclosure.

FIG. 5 illustrates a diagram of a context-trained interview system, in accordance with embodiments of the disclosure.

FIG. 6 illustrates a diagram of a response logging system, in accordance with embodiments of the disclosure.

FIGS. 7A, 7B, 7C, and 7D illustrate diagrams of user interface elements of an emergency response application, in accordance with embodiments of the disclosure.

FIG. 8 illustrates a flow diagram of a process for obtaining alert data for an emergency service provider, in accordance with embodiments of the disclosure.

FIG. 9 illustrates a flow diagram of an algorithm for transforming call audio into dispatchable alert data, in accordance with embodiments of the disclosure.

FIG. 10 illustrates a flow diagram of an algorithm for transforming audio data into actionable alert data, in accordance with embodiments of the disclosure.

FIG. 11 illustrates a diagram of a data structure for alert data in an emergency management system, in accordance with embodiments of the disclosure.

FIG. 12 illustrates a flow diagram of an algorithm for responding to administrative line calls made to an emergency call center, in accordance with embodiments of the disclosure.

FIG. 13 illustrates a flow diagram of an algorithm for back logging alerts at a monitoring agency, in accordance with embodiments of the disclosure.

### DETAILED DESCRIPTION

Various aspects of the disclosure include systems, devices, media, and methods for providing automated alarm intake and classification. Systems, processes, and algorithms of the present disclosure improve the operations of emergency service provider (ESP) computing systems, improve the operations of central station computing systems, and provide technical improvements to the technological field emergency response data platforms and emergency response communications, which may advantageously reduce emergency responder response times and improve operation of central stations.

In commercial and residential alarm systems, some sort of input (e.g., a sensor) triggers an alarm signal that gets sent to a centralized monitoring agency or station. The monitoring agency (or central station) is typically a privately owned organization that handles the verification of the alarms. These commercial and residential alarm systems may include various types of alarms (e.g., residential fire alarms, home security alarms, commercial fire alarms, bank teller alarms, and the like). If the alarm appears to be legitimate, the monitoring agency contacts a public emergency services agency on a non-emergency line, which is also referred to as a 10-digit line. A public emergency services agency may also be interchangeably referred to as an emergency communications center (ECC), a public safety answering point (PSAP), and/or an emergency service provider (ESP).

In response to a verified alarm, a monitoring agency calls a 10-digit line (10-digit telephone number) of an ECC. ECC's have an emergency line (e.g., for 9-1-1 calls) and a 10-digit line for monitoring agencies or non-emergency calls. As can be imagined, routing every triggered alarm through the same emergency line as other emergencies could contribute to the backlog associated with under-staffed emergency responders. Despite the separate lines, staff members (e.g., dispatchers) of ECCs respond to calls received on the 10-digit line and manually write or enter the information that is verbally provided over the phone call. The process of writing addresses leads to errors, is slow and cumbersome, and can contribute to delayed first responders. Many ECCs are heavily under-staffed, so the disclosed methods and systems for automated alarm intake and classification improve ECC system operations by improving address accuracy, reducing transcription times, and updating ECC user interfaces with actionable/dispatchable alerts. The disclosed methods and systems for automated alarm intake and classification may significantly assist in the handling and response to alarm alerts from monitoring agencies and enable ECCs to operate more efficiently while under-staffed.

The systems and/or methods for automated alarm intake and classification may include an automated interview system configured to transcribe calls made to an ECC 10-digit line and provide relevant information to a user interface of an ECC system. The automated interview system receives audio call data and transforms the audio call data into alert data that is paired with interview prompts in a data structure managed by an emergency management system. The automated interview system may include a transcription engine, interview logic, an artificial intelligence (AI) model, and one or more validation engines. The automated interview system may engage a caller to obtain a predetermined list of information that is transcribed, verified, clarified, and forwarded to a user interface at an ECC to enable a dispatcher to review and/or dispatch the alert. As used herein, dispatching an alert may mean contacting a primary ECC (e.g., 911 call center) from a secondary ECC (e.g., an alarm central station, a rail-based ECC, etc.) and/or contacting one or more emergency responders to respond to an alert or call. The automated interview system may be hosted by an emergency management system (EMS) and may engage with a caller of, for example, a monitoring agency by forwarding calls from the 10-digit line of an ECC to the EMS.

In one embodiment, the automated alarm intake and classification system may be configured to provide the alert to the ECC, even before all relevant information has been acquired. For example, after one or two (alert) parameters or categories have been acquired with the automated interview system and stored in a data structure, the EMS may be configured to generate an alert ID, pair/associate the alert ID with the parameters, and update an emergency response application at an ECC with partial alert data from the data structure. The partial alert data may include an alert ID, an alert type, and an incident address that is displayed in an emergency response application at an ECC, for example. As the automated interview system gathers additional information, the additional information may be populated in the data structure and then in the emergency response application in real-time or close to real-time to enable the dispatcher or telecommunicator to update dispatch instructions or information to emergency responders, according to an embodiment. Providing partial-alerts as live alerts or real-time alerts may significantly reduce the emergency responders' response times as the dispatcher may begin dispatching the alert without waiting for all information to be gathered.

Similar to the 10-digit line, ECCs are also equipped with an admin line that is typically separate from the emergency line (e.g., the 9-1-1 line) and separate from the alarm or secondary line (e.g., the 10-digit line). Telecommunicator or dispatcher resources are also consumed in responding to and re-directing callers for the admin line. The disclosed methods and systems may improve ECC system operations by implementing generative or predictive AI to handle and respond to admin line calls. The disclosed methods and systems may include a context-trained interview system configured to classify and handle (e.g., provide information, transfer the call, create an alert, etc.) calls made to an ECC admin line. The context-trained interview system is configured to at least partially rely on an AI model (e.g., a trained GPT) to determine the nature of the call to the admin line and perform one or more actions. The actions may include providing information to the caller, redirecting the caller to another telephone number (e.g., transferring the call to 211, 311, 411, 511, 611, 711, 811, 911, 988, etc.), and/or creating an alert (e.g., if the call content appears to include an emergency), for example. The context-trained interview system may be used to significantly assist in handling calls made to the admin line of an ECC to reduce the call volume handled by human dispatchers.

The context-trained interview system may be implemented in an emergency management system to support call handling for a variety of types of ECCs, in accordance with aspects of the disclosure. The context-trained interview system may be configured for use by a monitoring agency, by one or more lines of a 9-1-1 answering agency, for a railway ECC, and/or for a train company, for example. One or more models for an AI model of the context-trained interview system may be trained on questions, example scenarios, traffic trends, training manuals, and other context-specific historical data, for example. The training may be unsupervised training, or the training may be supervised training that is based on task-specific datasets to allow the model to adapt its general language understanding to specific domains or applications. Supervised learning can include training on pairs of inputs and desired outputs to adjust the model parameters to perform well on a specific task (e.g., interacting with callers of an ECC).

The EMS and automated interview system may be configured to support response logging, in accordance with aspects of the disclosure. Response logging advances the technological capabilities of a monitoring agency system by pairing, in a data structure, alert call information with responder actions. Response logging can include obtaining a report from a first responder about the alert and can include providing the reported information to the monitoring agency system that originated the alert (e.g., made the call to the 10-digit line). By providing the report back to the central station, the central station may generate analytics or metrics around the response times to develop or improve training or resource allocation/management, to improve monitoring agency operations, for example.

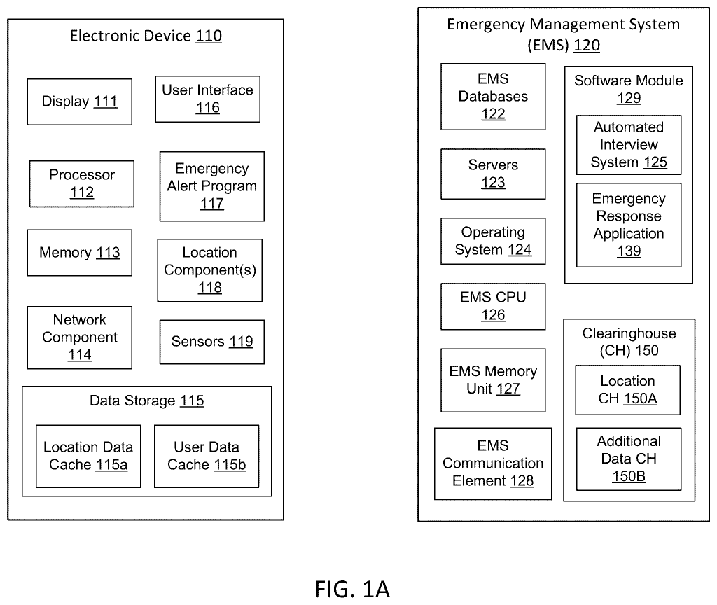

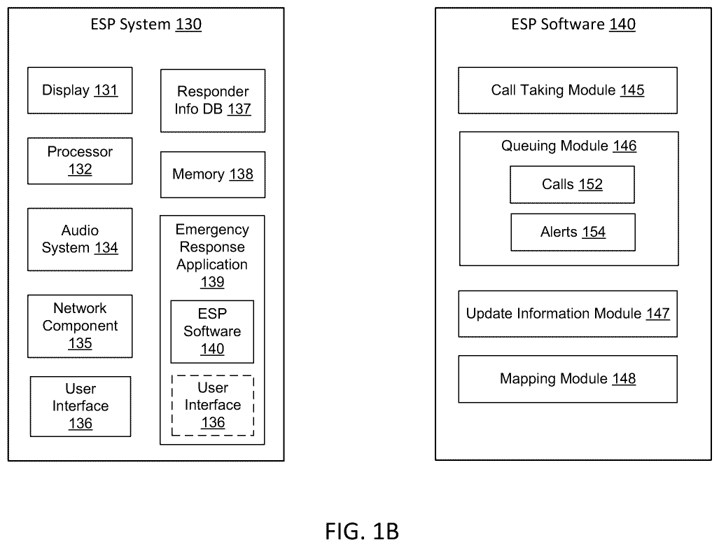

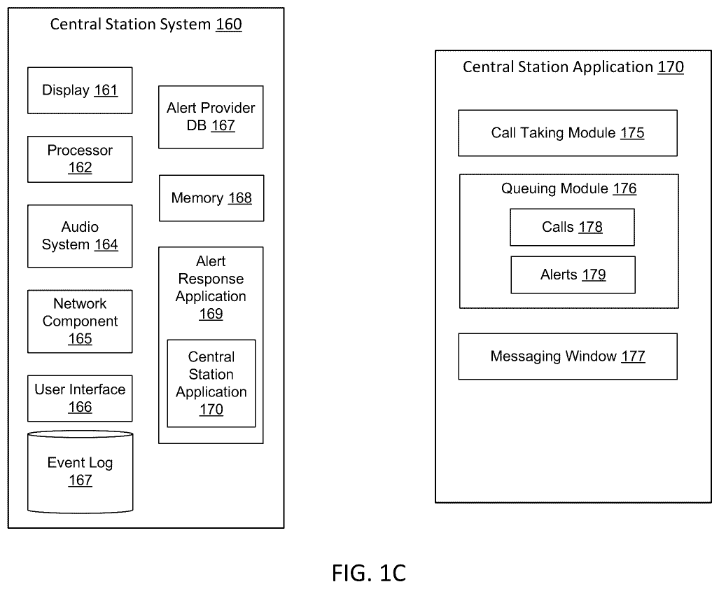

In accordance with aspects of the disclosure, an emergency management system includes an automated interview system that is configured to digitize the content of a 10-digit line phone call and provide or display the content in text format on an emergency management application. Potential advantages of the automated interview system include lightening the load of ECC staff, improving data accuracy, reducing dispatch time, and reducing emergency responder response time. The automated interview system prompts a (monitoring agency) caller to answer a series of questions. The answers get passed through a prompt flow that may include a decision tree and one or more AI models. The automated interview system prompts the caller with different questions that can be at least partially based on previous responses. Various embodiments and described hereafter and represented in FIGS. 1A-13.

The data structures and code described in this detailed description are typically stored on a computer-readable storage medium, which may be any device or medium that can store code and/or data for use by a computer system. The computer-readable storage medium is a non-transitory computer-readable storage medium and includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods, processes, and algorithms described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Electronic Device, EMS, and ESP

In various embodiments, disclosed herein are devices, systems, and methods for managing emergency data and/or alarm data for emergency response. FIG. 1A depicts exemplary diagrams of (i) an electronic device 110 and (ii) an emergency management system (EMS) 120 in accordance with one embodiment of the present invention. In some embodiments, the electronic device 110 is a digital processing device such as a communication device (e.g., mobile or cellular phone, computer, laptop, etc.). In some embodiments, the electronic device is a wearable device (e.g., a smartwatch). In some embodiments, the electronic device is an Internet of Things (IoT) device, such as a home assistant (e.g., an Amazon Echo) or a connected smoke detector (e.g., a Nest Protect smoke and carbon monoxide alarm). In some embodiments, the electronic device is a walkie-talkie or two-way radio.

In some embodiments, the electronic device 110 includes a display 111, a processor 112, a memory 113 (e.g., an EPROM memory, a RAM, or a solid-state memory), a network component 114 (e.g., an antenna and associated components, Wi-Fi adapters, Bluetooth adapters, etc.), a data storage 115, a user interface 116, an emergency alert program 117, one or more location components 118, and one or more sensors 119. In some embodiments, the processor 112 is implemented as one or more microprocessors, microcomputers, microcontrollers, digital signal processors, central processing units, state machines, logic circuitries, and/or devices that manipulate signals based on operational instructions. Among other capabilities, the processor 112 is configured to fetch and execute computer-readable instructions stored in the memory 113.

In some embodiments, the display 111 is part of the user interface 116 (e.g., a touchscreen is both a display and a user interface in that it provides an interface to receive user input or user interactions). In some embodiments, the user interface 116 includes physical buttons such as an on/off button or volume buttons. In some embodiments, the display 111 and/or the user interface 116 comprises a touchscreen (e.g., a capacitive touchscreen), which is capable of displaying information and receiving user input. In some embodiments, the communication device includes various accessories that allow for additional functionality. In some embodiments, these accessories (not shown) include one or more of the following: a microphone, a camera, speaker, a fingerprint scanner, health or environmental sensors, a USB or micro-USB port, a headphone jack, a card reader, a SIM card slot, or any combination thereof. In some embodiments, the one or more sensors include, but are not limited to: a gyroscope, an accelerometer, a thermometer, a heart rate sensor, a barometer, or a hematology analyzer. In some embodiments, the data storage 115 includes a location data cache 115A and a user data cache 115B. In some embodiments, the location data cache 115A is configured to store locations generated by the one or more location components 118.

In some embodiments, the emergency alert program 117 is an emergency response application or emergency response mobile application. In some embodiments, the emergency alert program 117 is configured to record user data, such as a name, address, or medical data of a user associated with the electronic device 110. In some embodiments, the emergency alert program 117 is configured to detect when an emergency request is generated or sent by the electronic device 110 (e.g., when a user uses the electronic device 110 to make an emergency call). In some embodiments, in response to detecting an emergency request generated or sent by the electronic device 110, the emergency alert program 117 is configured to deliver a notification to the EMS 120. In some embodiments, the notification is an HTTP post containing information regarding the emergency request. In some embodiments, the notification includes a location (e.g., a device-based hybrid location) generated by or for the electronic device 110. In some embodiments, in response to detecting an emergency request generated or sent by the electronic device 110, the emergency alert program 117 is configured to deliver user data to the EMS 120.

In some embodiments, as depicted in FIG. 1A, the emergency management system (EMS) 120 includes an EMS operating system 124, an EMS CPU 126, an EMS memory unit 127, an EMS communication element 128, and one or more software modules 129. In some embodiments, the EMS CPU 126 is implemented as one or more microprocessors, microcomputers, microcontrollers, digital signal processors, central processing units, state machines, logic circuitries, and/or devices that manipulate signals based on operational instructions. Among other capabilities, the EMS CPU 126 is configured to fetch and execute computer-readable instructions stored in the EMS memory unit 127. The EMS memory unit 127 optionally includes any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The EMS memory unit 127 optionally includes modules, routines, programs, objects, components, data structures, etc., which perform particular tasks or implement particular abstract data types.

The one or more software modules 129 may include an automated interview system 125 and an emergency response application 139. Automated interview system 125 may be configured to reduce the burden of manually handling non-emergency calls at a PSAP, in accordance with aspects of the disclosure. The automated interview system 125 is configured to receive a call to a 10-digit line of a PSAP, gather and verify information received from the caller, transcribe the received information, and provide the information as an alert in the emergency response application 139, according to an embodiment. In one embodiment, the automated interview system 125 is an interactive voice response (IVR) that integrates with an artificial intelligence (AI) model to determine the nature of the call (e.g., whether the call is associated with an emergency).

In some embodiments, the EMS 120 includes one or more EMS databases 122, one or more servers 123, and a clearinghouse 150. In some embodiments, the clearinghouse 150 is an input/output (I/O) interface configured to manage communications and data transfers to and from the EMS 120 and external systems and devices. In some embodiments, the clearinghouse 150 includes a variety of software and hardware interfaces, for example, a web interface, a graphical user interface (GUI), and the like. The clearinghouse 150 optionally enables the EMS 120 to communicate with other computing devices, such as web servers and external data servers (not shown). In some embodiments, the clearinghouse 150 facilitates multiple communications within a wide variety of networks and protocol types, including wired networks, for example, LAN, cable, etc., and wireless networks, such as WLAN, cellular, or satellite. In some embodiments, the clearinghouse 150 includes one or more ports for connecting a number of devices to one another or to another server. In some embodiments, the clearinghouse 150 includes one or more sub-clearinghouses, such as location clearinghouse 150A and additional data clearinghouse 150B, configured to manage the transfer of locations and additional data, respectively. In some embodiments, the EMS 120 additionally includes a user information module 161 that receives and stores user information (e.g., personal information, demographic information, medical information, location information, etc.) within the EMS 120. In some embodiments, users can submit user information through a website, web application, or mobile application, such as during a registration process for an emergency response application. In some embodiments, when the EMS 120 receives emergency data including user information, such as through an emergency alert received by the clearinghouse 150 (as described below), the EMS 120 stores the user information in the user information module 161. In some embodiments, user information stored within the user information module 161 is received by the EMS 120 from a third-party server system, as described below. In some embodiments, user information stored within the user information module 161 is associated with an identifier of a user or an electronic device associated with a user, such as a phone number or an email address.

In some embodiments, as depicted in FIG. 1B, an emergency service provider (ESP; e.g., a public safety answering point (PSAP)) system 130 includes one or more of a display 131, a user interface 136, at least one central processing unit or processor 132, a network component 135, an audio system 134 (e.g., microphone, speaker and/or a call-taking headset), and a computer program implemented as an emergency response application 139 that may operate as a PSAP Emergency Display Application or Location Display Program. In some embodiments, the emergency response application 139 comprises one or more software modules 140. In some embodiments, the ESP system 130 comprises a database of emergency responders 137, such as medical assets, police assets, fire response assets, rescue assets, safety assets, etc.

In some embodiments, as depicted in FIG. 1B, the emergency response application 139 installed on ESP system 130 comprises ESP software 140. ESP software 140 may include a call taking module 145, a queuing module 146, an updated information module 147, a mapping module 148, or a combination thereof. Call taking module 145 may integrate VOIP or a call receiving system with user interface 136 to enable a telecommunicator to see, receive, forward, hold, and terminate calls received at a PSAP or other ECC. Queuing module 146 may provide a visual list of calls 152 that have been received and/or handled and may provide a visual list of alerts 154 that have been received and/or handled. Update information module 147 may query one or more services and/or databases to update calls 152, alerts 154, and/or location data in the user interface 136. The user interface 136 may be part of the emergency response application 139. In some embodiments, the emergency response application 139 displays the information on a map (e.g., on the display 131), which may be updated with mapping module 148. In some embodiments, location and supplemental information is displayed for emergency service providers (e.g., police, fire, medical, etc.) and/or responders on their devices. In some embodiments, the responder device program displays the emergency location on a map.

### Emergency Clearinghouse

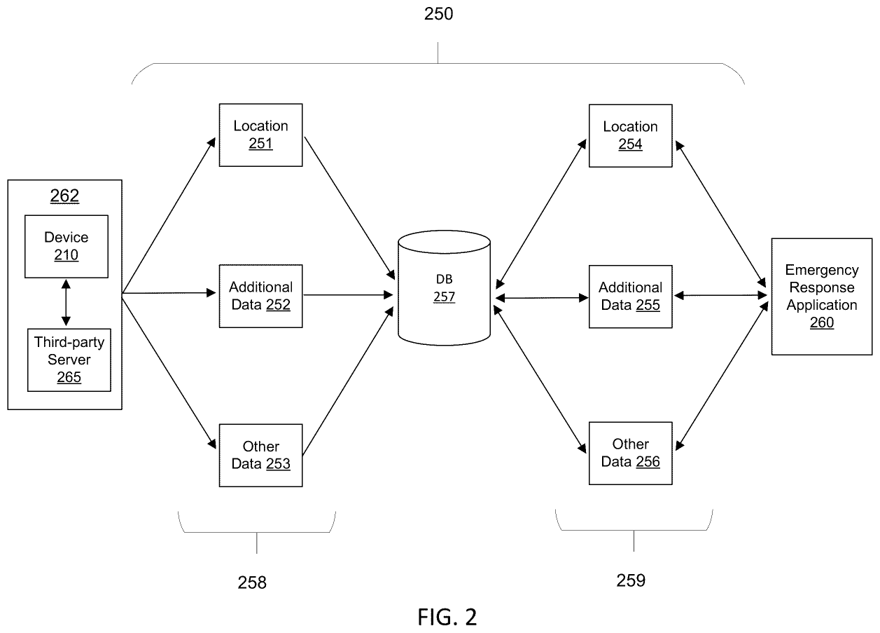

In some embodiments, as mentioned above with respect to FIG. 1A, the emergency management system (EMS) 120 includes a clearinghouse 150 (also referred to as an “Emergency Clearinghouse”) for storing, retrieving, and transmitting emergency data. In some embodiments, the clearinghouse 150 includes a location clearinghouse 150A and an additional data clearinghouse 150B. In some embodiments, the location clearinghouse 150A includes a location ingestion module and a location retrieval module, as described below with respect to FIG. 2. In some embodiments, the additional data clearinghouse 150B includes an additional data ingestion module and an additional data retrieval module, as described below with respect to FIG. 2. In other embodiments, additional data and location data (hereinafter “emergency data”) are stored in one or more databases in a distributed manner. In some embodiments, the emergency data is stored in an external or third-party server that is accessible to the EMS 120. The clearinghouse 150 optionally functions as an interface that receives and stores emergency data from electronic or communication devices that are then retrieved, transmitted, and/or distributed to recipients (e.g., emergency service providers) before, during, or after emergencies. As described above, the clearinghouse optionally receives emergency data from electronic or communication devices such as mobile phones, wearable devices, laptop or desktop computers, personal assistants, intelligent vehicle systems, home security systems, IoT devices, camera feeds, and other sources (e.g., emergency response assets and asset service providers, as described in further detail below). As described above and below, emergency data optionally includes locations or additional data such as medical history, personal information, or contact information. In some embodiments, during an emergency, the clearinghouse 150 detects the emergency and/or otherwise identifies the need to provide emergency data pertaining to the emergency. The clearinghouse 150 then identifies any emergency data pertaining to the emergency stored within the clearinghouse 150 and transmits the pertinent emergency data to the requesting ESP. Accordingly, in some embodiments, the clearinghouse 150 acts as a data pipeline that automatically pushes emergency data to an ESP (e.g., to the emergency response application 139) that might otherwise be without access to emergency data that is critical to most effectively and efficiently responding to an emergency. Accordingly, location data stored within the clearinghouse 150 allows emergency responders to arrive at the scene of an emergency faster, and additional data stored within the clearinghouse 150 allows emergency responders to be better prepared for the emergencies they face.

For example, in one embodiment, an emergency alert is triggered by an electronic device 110 (e.g., by pressing a soft button, a physical button, voice command, or gesture) or autonomously based on sensor data (e.g., smoke alarms). In this example, the user then confirms the emergency and/or provides authorization for sending the emergency alert. Emergency data, such as an enhanced location and additional data regarding the user (e.g., the user's medical history) is delivered by the electronic device 110 to the EMS 120 and stored in the clearinghouse 150 (e.g., in the location clearinghouse 150A and the additional data clearinghouse 150B). In some embodiments, the EMS 120 or clearinghouse 150 formats the emergency data into a format that is compatible with industry standards for storing and sharing emergency data. For example, in some embodiments, the emergency data is formatted to be compatible with National Emergency Number Association (NENA) standards. In some embodiments, the clearinghouse 150 transmits the emergency data to a receiving party in response to receiving a query from the receiving party, as described below. In some embodiments, the clearinghouse 150 automatically pushes the emergency data to a receiving party (e.g., without receiving a query from the receiving party), such as a PSAP (e.g., ESP system 130). For example, in some embodiments, the clearinghouse 150 or emergency management system 120 housing the clearinghouse automatically pushes the emergency data to a receiving party using a subscription system, as described below.

In some embodiments, as mentioned above, a requesting party (such as a PSAP responding to an emergency call) queries the clearinghouse 150 with an emergency data request (such as a HTTP GET request). In some embodiments, the emergency data request is in the form of the Location Information Server (LIS) protocol. In response to the emergency data request, the EMS 120 or clearinghouse 150 sends an appropriate response including relevant emergency data to the requesting party via an encrypted pathway. In some embodiments, the emergency data request is in the form of HTTP-Enabled Location Delivery (HELD) and the response from the EMS 120 or clearinghouse 150 is in the form of Presence Information Data Format Location Object (PIDF-LO). In some embodiments, the emergency data request includes an authorization code (also referred to as an “authorization token” or “temporary access token”) in the body, header, or metadata of the request, and the EMS 120 checks that the authorization code is active before providing a response to the requesting party. In some embodiments, authorization is provided in the “Authorization” header of the emergency data request using HTTP Basic Authentication. For example, in some embodiments, authorization is base64-encoded username and password for an account associated with the requesting party. In some embodiments, emergency data requests are sent over public networks using API access keys or credentials. In some embodiments, Transport Layer Security (TLS) is used in the requests and responses from the EMS 120 for encryption security. In some embodiments, the call taking module 145 includes a call-handling application, which may be provided by a third-party vendor. In some embodiments, an ESP personnel interacts with the call-handling application to send an emergency data request to the EMS 120. In some embodiments, the response from the EMS 120 is displayed at the ESP display 131.

In some embodiments, as described above, emergency data includes locations and additional data. In some embodiments, emergency data includes one or more emergency data categories (also referred to as “data categories”). In some embodiments, the emergency data categories include: service data reference, full name, email, emergency contacts, addresses, language, occupation, phone numbers, websites, gender, height, weight, ethnicity, profile picture, allergies, medical conditions, medications, disabilities, blood type, medical notes, birthday, and additional comments. In some embodiments, emergency data categories are tagged with tags for specific types of data such as “demographics” or “medical data.” For example, in some embodiments, gender, height, weight, ethnicity, profile picture (image-url) are tagged as demographic data. In some embodiments, medical data protected under HIPAA and other laws are tagged as “HIPAA” or “private.” In some embodiments, medical data includes information on one or more of allergies, medical condition(s) or illness(es), medication(s), disabilities, blood type, medical note(s), and other medical information. In some embodiments, medical information protected under HIPAA are encrypted and/or anonymized. In some embodiments, some data are tagged as “general” or another similar tag, wherein access is not specifically restricted.

An example of an additional data communication from the EMS 120 in a standard format compatible with industry standards, PIDF-LO, is shown below.

### HTTP/1.1 200 OK

### Date: Tue, 1 Dec. 2016 23:27:30 GMT

### Content-Length: 489

Content-Type: application/EmergencyCallData.DeviceInfo+xml
<dev:EmergencyCallData.DeviceInfo xmlns:dev=“urn:ietf:params:xml:ns:EmergencyCallData:DeviceInfo”>
<dev:DataProviderReference>d4b3072df.201409182208075@example.org

In some embodiments, when the emergency data is stored at a third-party server and receives a request for emergency data from the EMS 120, as a database query, the third-party server formats the requested emergency data and stores this information in an alternate database, and forwards either a response or a reference to the alternate database for accessing the emergency data requested by the EMS 120, which is provided to the ESP 130 over a hybrid analog and/or a data communication channel, depending on the capabilities of ESP 130. In some embodiments, the third-party server stores the emergency data, requested by the EMS 120 or directly by the ESP 130, in the alternate database for a certain period of time after receiving the request for the emergency data regarding a user and any electronic devices 110. In some embodiments, this period of time is a timer value (e.g., a timer countdown or a set time point) defined by the EMS 120 and the third-party server in conjunction with each other prior to the addition of the requested emergency data to the alternate database at the third-party server. In some embodiments, once the timer value has passed and no new requests for the emergency data pertaining to the particular user and the electronic device 110, or other devices associated with the user, are received by the third-party server, then the third-party server marks the particular alternate database entries to be deleted and waits for another, different, time-out interval. In some embodiments, once this particular second time-out interval has also been completed and no new requests for location data for the particular user or associated electronic devices 110 are received by the third-party server, the third-party server removes the specific marked entries from the alternate database in the next cycle of updates for the alternate database. In some embodiments, after adding the emergency data in the alternate database by the third-party server, the third-party server keeps updating the emergency data in the alternate database on a periodic, or as-needed basis, for the purpose of keeping the emergency data about the user or electronic device 110 current for providing the most recent and accurate emergency data to the EMS 120 and the ESP 130 for the purposes of responding to a request for emergency assistance. In some embodiments, the third-party server is updated by the EMS 120 for all the emergency data pertaining to all users and their associated electronic devices 110 that are served by the EMS 120 at any current time.

In some non-emergency situations, there is a need to access location data, user data, emergency data or sensor data. For example, in some embodiments, a user of an electronic device 110 grants authorization to family members to access location data for the user. Accordingly, when a family member requests location data for a user, access is granted if there is proper authorization. As another example, in some embodiments, a taxi operations company requests and obtains location data of one or more fleet members to keep track of its vehicles (e.g., via onboard vehicle console or terminal).

Various embodiments and applications of the clearinghouse 150 are described in detail herein. However, the embodiments and applications described herein should not be considered exhaustive or limiting in any way.

In some embodiments, as depicted in FIG. 1C, a central station system 160 includes one or more of a display 161, a user interface 166, at least one central processing unit or processor 162, a network component 165, an audio system 164 (e.g., microphone, speaker and/or a call-taking headset), an event log 167 and a computer program implemented as an alert response application 169. In some embodiments, the alert response application 169 comprises a central station application 170. In some embodiments, the central station system 160 comprises a event log 167 that may be implemented as a database, table, array, or other data structure for alert provider information. The alert provider information may include names, addresses, service types, building maps, vehicle information (e.g., model, age, size) for companies such as sensor alarm companies (e.g., Honeywell), food delivery companies (e.g., Grubhub), ridesharing companies (e.g., Uber), parcel delivery companies (e.g., UPS), retailers (e.g., Amazon), etc. The central station system 160 may be operated or configured to handle alerts for a number of third parties to streamline response to and handling of alerts (e.g., sensor alarm, vehicle accidents, unsafe situations for delivery personnel, etc.), for example.

In some embodiments, as depicted in FIG. 1C, the alert response application 169 installed on central station system 160 includes a central station application 170. Central station application 140 may include a call taking module 175, a queuing module 176, a messaging window 177, or a combination thereof. Call taking module 175 may integrate VOIP or a call receiving system with user interface 166 to enable a telecommunicator to see, receive, forward, hold, and terminate calls received at a central station or monitoring agency. Queuing module 176 may provide a visual list of calls 178 that have been received and/or handled and may provide a visual list of alerts 179 that have been received and/or handled. Alerts 179 may be received directly from a smart sensor (e.g., a smart home monitoring device) or may be received from a third-party server that monitors the sensors and forwards any alarms or alerts to the central station system 160, according to various embodiments. Messaging window 177 may enable a monitoring agent to correspond with devices or people associated with an alert. The user interface 166 may be part of the alert response application 169.

Event log 167 is a data structure that is operable to store and associate alerts, a dispatch disposition, and an emergency responder action, according to an embodiment. For example, for a particular alert (e.g., identified with an alert ID), event log 167 may associate a dispatch disposition (e.g., in queue, contacting responders, dispatched, resolved, closed, etc.) with the particular alert. The ECC dispatcher may use systems and methods of the present disclosure to provide a central station or central station system with the dispatch disposition to enable event log 167 to be updated. Event log 167 may also maintain time stamp records for particular events (e.g., alert received, dispatch disposition status, emergency responder action, etc.). After an emergency responder addresses or resolves a particular alert, the emergency responder may provide a report (e.g., person visited, resolved, closed, case opened for investigation, investigating, fire extinguished, premises checked, etc.) for the emergency response action to an ECC, and the ECC may use systems and methods of the disclosure to provide the report to the central station to enable event log updates to include the emergency response action and/or report.

FIG. 2 depicts an embodiment of a clearinghouse 250 for storing and retrieving emergency data and/or alert/alarm data. In some embodiments, the clearinghouse 250 includes a set of ingestion modules 258 (also referred to as “ingestion modules”) and a set of retrieval modules 259 (also referred to as “retrieval modules”). The set of ingestion modules 258 is configured to receive various forms of emergency data from various emergency data sources 262, such as an electronic device 210 or a third-party server 265. In some embodiments, an electronic device 210 is a communication device (e.g., a mobile phone), a wearable device (e.g., a smartwatch), or an internet of things (IoT) device (e.g., a smart speaker) that can communicate with one or more of the ingestion modules within the set of ingestion modules 258. In some embodiments, a third-party server 265 stores data that is not generated by or stored within an electronic device. For example, in some embodiments, third-party server 265 includes a database of static medical information that can be sent to the clearinghouse during an emergency. In some embodiments, when the EMS 120 detects an emergency (e.g., when a person calls 9-1-1), the clearinghouse 250 can query an emergency data source 262 for emergency data regarding the emergency. For example, in some embodiments, in response to detecting a 9-1-1 call made from a mobile phone, the additional data ingestion module 252 (as described below) sends a query including the phone number of the mobile phone to a third-party server 265 that stores static medical information. The third-party server 265 can then return any available medical information associated with the phone number of the mobile phone to the additional data ingestion module. In some embodiments, multiple ingestion modules within the set of ingestion modules can receive emergency data for a single emergency. For example, in some embodiments, when a person calls 9-1-1 from a mobile phone, the mobile phone can send a device-based hybrid location to the location ingestion module 251 and demographic data to the additional data ingestion module 252. In some embodiments, the clearinghouse 250 can receive emergency data from multiple emergency data sources 262 for a single emergency. For example, in some embodiments, when a person calls 9-1-1 from a mobile phone, the clearinghouse 250 can receive a location from the mobile phone (such as through the location ingestion module 251) and a heartrate from a smartwatch that the person is wearing (such as through additional data ingestion module 252). Or for example, in some embodiments, when a person calls 9-1-1 from a mobile phone, the clearinghouse 250 can receive a location from the mobile phone and medical information associated with the person from a third-party server 265.

The set of ingestion modules 258 optionally include a location ingestion module 251, an additional data ingestion module 252, and one or more other data ingestion modules 253. In some embodiments, the location ingestion module 251 is an emergency location service ingestion interface for posting or receiving emergency locations. In some embodiments, the location ingestion module 251 is a REST API that receives an HTTP POST including location data when an emergency alert is generated (e.g., when an emergency call is made from a cell phone). The location data includes a location generated concurrently or in response to the generation of the emergency alert. In some embodiments, the location data includes a location generated before the emergency alert. For example, when an emergency call is made from a cell phone, thereby generating an emergency alert, the location ingestion module 251 receives a location recently generated by the phone but before the emergency alert was generated, ensuring that a location for the emergency is available as quickly as possible. In some embodiments, the location data includes a device-based hybrid location generated by an electronic device 210 that generated the emergency alert. In some embodiments, the location data includes a location generated by a second electronic device communicatively coupled to the electronic device that generated the emergency alert. The location ingestion module 251 is integrated into an electronic device 210 through a mobile application installed on the device 210 or integrated into the firmware or operating system of the electronic device 210.

In some embodiments, the location data is generated by the electronic device 210 before the emergency and is accessible to a PSAP during an emergency. For example, a taxi company may have software that transmits the location of its cars or assets to the emergency clearinghouse 250 preemptively. Thus, when an emergency arises, the location of the affected taxi can be made accessible quicker to send help. In some embodiments, the location data is generated by the electronic device 210 after the emergency has commenced and is made accessible to a PSAP or central station during the on-going emergency or alarm-triggering event. For example, updated location data of a hijacked taxi is also periodically transmitted to the emergency clearinghouse 250 and made accessible to a PSAP and/or central station.

In some embodiments, the additional data ingestion module 252 is an interface for posting or receiving static or dynamic emergency profile data (hereinafter, “additional data” or “additional information”). In some embodiments, additional data comprises medical data, personal data, demographic data, health data, or any combination thereof. Examples of medical data include information relating to a person's medical history, such as past surgeries or preexisting conditions. Examples of personal data include a person's name, date of birth, height, weight, occupation, address(es) (e.g., home address, work address, etc.), spoken languages, and other personal information. Examples of demographic data include a person's gender, ethnicity, age, etc. Examples of health data include information such as a person's blood type or heartrate. In some embodiments, additional data comprises data received from connected devices such as vehicles, IoT devices, and wearable devices. For example, some intelligent vehicle systems generate and send data regarding a crash, such as the speed at which the vehicle was moving just before the collision, where the vehicle was struck, the number of occupants, etc. In some embodiments, the additional data ingestion module 252 is a REST API (e.g., a JSON (JavaScript Object Notation) REST API). For example, in some embodiments, when an emergency call is made from a cell phone, thereby generating an emergency alert, the cell phone receives a heartrate of the person who made the emergency call from a smartwatch worn by the person and communicatively coupled to the cell phone (e.g., Wi-Fi or Bluetooth connectivity). The cell phone sends the heartrate to the additional data ingestion module 252, along with any other additional data, in an HTTP POST. In some embodiments, the additional data ingestion module 252 is integrated into an electronic device 210 through a mobile application installed on the device 210 or integrated into the firmware or operating system of the electronic device 210. In some embodiments, additional data is sent to the additional data ingestion module 252 from a network server. The additional data ingestion module 252 is accessed by any connected platform that receives data that might be relevant in an emergency. Connected platforms optionally send additional data to the additional data ingestion module 252 at any time. For example, in some embodiments, a website, web application, or mobile application integrated with the additional data ingestion module 252 that allows users to create profiles sends additional data included in the profiles to the additional data ingestion module 252 every time a profile is created or updated.

In some embodiments, the set of ingestion modules 258 includes one or more other data ingestion modules 253. Another data ingestion module 253 is optionally an interface for posting or receiving data relevant to emergencies that is not received by the location ingestion module 251 or the additional data ingestion module 252. In some embodiments, the other data ingestion module 253 receives audio or video streams during an emergency from electronic or communication devices associated with the emergency or proximal to the emergency. For example, an emergency alert is generated by an intelligent vehicle system installed in a vehicle in response to the vehicle experiencing a collision. In this example, the emergency alert is sent to the EMS 120 by the intelligent vehicle system or by an electronic device communicatively coupled to the intelligent vehicle system, such as a cell phone coupled to the intelligent vehicle system via Bluetooth. In response to generating the emergency alert, the intelligent vehicle system additionally begins streaming audio and video from microphones and cameras installed inside or outside of the vehicle to the clearinghouse 250 through the other data ingestion module 253. A cell phone communicatively coupled to the intelligent vehicle system additionally or alternatively streams audio or video from microphones and cameras integrated into the cell phone to the clearinghouse 250 through the other data ingestion module 253. In some embodiments, the one or more other data ingestion modules 253 are REST APIs that are accessed with an HTTP POST.

After receiving the relevant data, the set of ingestion modules 258 can store the data in one or more clearinghouse databases 257. For example, in some embodiments, the clearinghouse databases 257 includes a location database and an additional data database. In some embodiments, as described above, the one or more clearinghouse databases 257 are stored on a third-party server communicatively coupled to or otherwise accessible by the EMS 120. In some embodiments, the set of ingestion modules 258 tags or otherwise associates the data received by the modules with an identifier of a user or device associated with the data. For example, the set of ingestions modules 258 tag the data the received by the modules with a user ID number, an email address, or a phone number (e.g., caller ID). In some embodiments, the ingestion modules 258 tag the data received by the clearinghouse 250 based on the data source (e.g., device name or type, application name, username, phone number, corporate account, etc.).

In some embodiments, the emergency data maintained by the clearinghouse is purged. In some embodiments, the data is purged on a regular or periodic basis. In some embodiments, data that is older than a defined threshold is purged. In some embodiments, different data types are purged according to different schedules and/or thresholds. For example, dynamic data (e.g., data that is subject to constant or regular change) such as location data may be more likely to become out-of-date over time and so may be purged more frequently than static data such as a permanent home address, which may remain permanently in the database until it is replaced with an updated address.

In some embodiments, an individual or group of individuals are associated with multiple identifiers. For example, the location ingestion module 251 receives a location generated by a phone associated with the phone number +1-555-555-5555, associated with John Doe. The additional data ingestion module 252 also receives a heartrate from a smartwatch associated with the email address johndoe@email.com, also associated with John Doe. In this example, the set of ingestion modules 258 tag the location with the phone number “+1-555-555-5555,” tag the heartrate with the email address “johndoe@email.com,” and associate both the location and the heartrate with John Doe in the clearinghouse databases 257.

In some embodiments, as depicted in FIG. 2, the clearinghouse 250 includes a set of retrieval modules 259. The set of retrieval modules 259 optionally include a location retrieval module 254, an additional data retrieval module 255, and one or more other data retrieval modules 256. In some embodiments, the location retrieval module 254 is an interface for retrieving location data from the clearinghouse databases 257. In some embodiments, the location retrieval module 254 is a JSON REST API that receives a query or request (e.g., in the form of an HTTP GET request) from a requesting party, such as an ESP. In some embodiments, the request is sent from a call-taking application (e.g., call taking module 145) integrated into the ESP system 130. In some embodiments, the request (also referred to as an “emergency data request”) is sent from an emergency response application 260. In some embodiments, the location retrieval module 254 provides a single GET endpoint for retrieving either the latest or paginated list of locations for a specific caller ID (e.g., an identifier of a user or an electronic device associated with a user, such as a phone number). For example, as described above, a phone number associated with a device 210 from which a location was received is included in the header, body, or metadata of the request sent to the location retrieval module 254. The clearinghouse 250 then retrieves a location or set of locations from the clearinghouse databases 257 and deliver the location or set of locations to the requesting party. In some embodiments, the location retrieval module 254 is a location information server (LIS). In some embodiments, the LIS is a NG911 standards-based XML API for the retrieval of location data from the clearinghouse databases 257. In some embodiments, as described above, the location retrieval module 254 accepts HELD requests from requesting parties and returns location data for a specific caller ID or anonymous reference. However, in some embodiments, the location retrieval module 254 automatically retrieves and transmits location data using a subscription system, as described below.

As depicted in FIG. 2, the set of retrieval modules 259 optionally include an additional data retrieval module 255. In some embodiments, the additional data retrieval module 255 is a JSON REST API for the retrieval of emergency or additional data. As described above, additional data optionally includes medical data, personal data, demographic data, and health data. Additional data also optionally includes data received from connected devices such as vehicles, IoT devices, and wearable devices. In some embodiments, the additional data retrieval module 255 receives a query or request (e.g., in the form of an HTTP GET request) from a requesting party, such as an ESP. In some embodiments, the request (also referred to as an “emergency data request”) is sent from an emergency response application 260. The additional data then retrieves additional data associated with a specific or particular identifier of a user or an electronic device associated with the user, such as a phone number, and returns the data to the requesting party. In some embodiments, the set of retrieval modules 259 further includes one or more other data retrieval modules 256, which function similarly to the location retrieval module 254 and additional data retrieval module 255, for the retrieval of data stored in the clearinghouse databases 257 not retrieved by the location retrieval module 254 or additional data retrieval module 255. However, in some embodiments, the additional data retrieval module 255 automatically retrieves and transmits additional data using a subscription system, as described below.

In some embodiments, a retrieval module within the set of retrieval modules 259 and a corresponding ingestion module within the set of ingestion modules 258 form a sub-clearinghouse. For example, in some embodiments, location ingestion module 251 and location retrieval module 254 combine to form location clearinghouse 150A (as shown in FIG. 1B). Likewise, in some embodiments, additional data ingestion module 252 and additional data retrieval module 255 combine to form additional data clearinghouse 150B. In some embodiments, a requesting party is only given access to a particular sub-clearinghouse. For example, a police officer is only given access to the location clearinghouse 150A, while an EMT (emergency medical technician) is only given access to the additional data clearinghouse 150B. However, a requesting party is given differential access to the clearinghouse 150, sub-clearinghouses, or particular emergency data categories within the clearinghouse 150 based on any factor or set of factors. In some embodiments, a requesting party initiates a query or request (i.e., an emergency data request) using an emergency response application 260 (as described below), which in turn generates the query and transmits the query to the clearinghouse 250.

In some embodiments, the clearinghouse 250 includes an emergency data streaming module or streaming module (not shown). In some embodiments, a streaming module is capable of both receiving and transmitting emergency data, but emergency data received by the streaming module is not stored within a database. Instead, emergency data is streamed through the streaming module without being committed to memory within the clearinghouse 250. In some embodiments, the streaming module establishes an active or persistent communication link (e.g., a websocket connection) between the EMS or clearinghouse 250 and an emergency data recipient. For example, in some embodiments in which emergency data is pushed from the EMS or clearinghouse 250 to an emergency data recipient, the streaming module can establish a persistent communication link between the EMS or clearinghouse 250 and the emergency data recipient, and any emergency data that is received by the EMS or clearinghouse 250 to which the emergency data recipient is subscribed is pushed to the emergency data recipient through the persistent communication link without being committed to memory within the EMS or clearinghouse 250.

As described above, in some embodiments, an emergency management system (EMS) maintains a clearinghouse 250 that obtains and shares emergency data to aid emergency service providers (ESPs) in responding to emergencies and to aid central stations in responding to various alerts that may or may not be emergencies. During an emergency, in some embodiments, an ESP can send an emergency data request to the EMS through the emergency response application 260, and, in response, the EMS can send any available emergency data associated with the emergency back to the emergency response application 260. In some embodiments, as described above, the emergency response application 260 includes an identifier associated with an emergency alert in the emergency data request. The EMS can then use the identifier associated with the emergency alert to retrieve emergency data associated with the emergency alert from the clearinghouse. For example, as described above, an ESP 230 (e.g., a public safety answering point (PSAP)) can receive an emergency alert in the form of a 9-1-1 phone call (representative of an emergency or potential emergency) from a mobile phone associated with a phone number (e.g., (555) 555-5555). The ESP 230 can then send an emergency data request including the phone number (i.e., the identifier of the emergency alert) to the EMS, which can then retrieve any emergency data within or otherwise accessible by the clearinghouse 250 associated with the phone number and return the available emergency data to the requesting ESP 230. This process of returning emergency data to the emergency response application 260 in response to an emergency data request is referred to as “pulling” emergency data from the clearinghouse.

However, in some embodiments, the EMS can “push” emergency data and/or alert data from the clearinghouse 250 to the emergency/alert response application (i.e., the EMS can send emergency data to the emergency response application 260 without receiving an emergency data request). In some embodiments, the EMS pushes emergency data to the emergency response application 260 using an emergency data subscription system. Using the emergency data subscription system, a recipient (or potential recipient) of emergency data from the clearinghouse 250 can subscribe to the clearinghouse 250 for a particular device identifier, user identifier, or ESP account (hereinafter, “subscription”). After subscribing to a subscription, the recipient (e.g., an ESP) may automatically receive updates regarding the subscription without first sending an emergency data request. For example, in some embodiments, if an ESP subscribes to a phone number, whenever the clearinghouse 250 receives updated emergency data associated with the phone number, the clearinghouse 250 can automatically send the updated emergency data associated with the phone number to the ESP (e.g., through the emergency response application 260), without first receiving an emergency data request including the phone number. For example, in some embodiments, if a recipient is subscribed to a particular phone number, and the clearinghouse 250 receives a new or updated location associated with the particular phone number, the clearinghouse 250 will instantly and automatically push the new or updated location associated with the particular phone number to the recipient the moment that the new or updated location is received by the clearinghouse 250, without the recipient having to send an emergency data request. In some embodiments, when an ESP or ESP personnel accesses the emergency response application 260 at a computing device associated with the ESP or ESP personnel, the EMS establishes a persistent or active communication link (e.g., a websocket connection) with the computing device in order to push emergency data regarding a subscription to which the ESP or ESP personnel is subscribed to the emergency response application 260.

In some embodiments, an active communication link is a connection, or a potential connection (e.g., two corresponding endpoints), between two entities (e.g., an EMS and an ESP) through which data can be freely transmitted (i.e., without a recipient entity having to actively accept transmitted data). In some embodiments, an active communication link is a persistent communication link. In some embodiments, a persistent communication link is a communication link that endures for a period of time that is not dependent on the transmission of a particular packet of data. For example, in some embodiments, a persistent communication link between two entities (e.g., an EMS and an ESP) endures until the communication link is actively terminated by one of the entities, as opposed to passively terminating once a particular packet of data (e.g., a particular emergency alert) has been transmitted. In another example, a persistent communication link endures for a predetermined amount of time (e.g., five minutes or an hour). In another example, a persistent communication link established between an EMS and an ESP through an emergency response application endures until a login session on the emergency response application is terminated or the emergency response application itself is terminated. In some embodiments, a persistent communication link is a WebSocket connection. WebSocket is a type of computer communications protocol. A WebSocket connection is a longstanding or persistent internet connection between a client and a server that allows for bidirectional communication between the client and server without the client needing to send data requests to the server, which differentiates the WebSocket computer communications protocol from other types of computer communications protocols such as the Hypertext Transfer Protocol (HTTP). The WebSocket protocol is often used by chat clients to facilitate user to user webchats. In some embodiments, the EMS establishes an active communication link with a computing device (e.g., an ESP console 130) in response to receiving an emergency data request. In some embodiments, the EMS establishes an active communication link with an ESP console when an ESP personnel logs into the emergency response application 260 at the ESP console. In some embodiments, the EMS establishes an active communication link with a responder device when an ESP personnel logs into the emergency response application 260 at the responder device. In some embodiments, an active communication link established between the EMS and a computing device associated with ESP personnel is maintained by the EMS for the duration of the ESP personnel's log-in session.

In some embodiments, the EMS automatically subscribes a recipient to a subscription (e.g., a particular device identifier or user identifier) in response to receiving an emergency data request including the subscription or an identifier of the subscription. For example, in some embodiments, when an ESP personnel sends an emergency data request including a phone number to the EMS through their ESP console (e.g., through the emergency response application 260), the EMS subscribes the ESP personnel to the phone number and establishes a persistent or active communication link with the ESP console. Then, whenever the clearinghouse 250 receives updated emergency data associated with the phone number, the EMS can automatically push the updated emergency data associated with the phone number to the ESP console. For example, an ESP personnel logs into an emergency response application 260 in communication with the EMS on the ESP personnel's ESP console. Subsequently, the ESP personnel receives a 9-1-1 call from a mobile phone and then generates and sends an emergency data request including the phone number of the mobile phone to the EMS through the emergency response application 260. The EMS then uses the phone number of the mobile phone to retrieve the most recent location associated with the mobile phone received by the clearinghouse and returns the most recent location associated with the mobile phone to the ESP personnel through the emergency response application 260. The EMS simultaneously subscribes the ESP personnel to the phone number of the mobile phone and establishes a WebSocket connection between the EMS and the ESP console and automatically pushes any updated emergency data (e.g., enhanced locations) associated with the phone number received by the clearinghouse to the emergency response application 260 as soon as the updated emergency data associated with the phone number is received by the clearinghouse 250.

In some embodiments, an ESP is associated with an identifier of the ESP (e.g., a unique ESP account ID; also referred to as an “ESP identifier”) that an ESP or ESP personnel can subscribe to. The EMS can then establish a persistent or active communication link with a computing device associated with an ESP or ESP personnel subscribed to the unique ESP identifier and push emergency data associated with the unique ESP identifier to the computing device (e.g., through the emergency response application 260) whenever new or updated emergency data associated or tagged with the unique ESP identifier is received by the clearinghouse 250. For example, in some embodiments, when the clearinghouse 250 receives a location (e.g., an emergency location) associated with an emergency alert (e.g., when a person calls 9-1-1 from a mobile phone and the mobile phone responsively sends a current location of the mobile phone to the clearinghouse 250), the EMS retrieves one or more geofences (as described below) associated with each ESP registered with the EMS and determines which (if any) of the geofences that the location associated with the emergency alert falls within. The EMS then tags the location associated with the emergency alert with the unique ESP identifiers associated with each of the ESPs associated with geofences that the location associated with the emergency alert falls within. For example, if four ESPs are registered with the EMS—ESP A, ESP B, ESP C, and ESP D—and the clearinghouse 250 receives a location associated with an emergency that falls within the one or more of the geofences associated with ESP A and ESP D, the EMS can tag the location associated with the emergency alert with the unique ESP account ID associated with ESP A and the unique ESP account ID associated with ESP D. The EMS can then push the location associated with the emergency alert to any ESPs or ESP personnel with an established persistent or active communication link with the EMS and currently subscribed to either the unique ESP account ID for ESP A or the unique ESP account ID for ESP D. In some embodiments, when an ESP personnel logs into the emergency response application 260, a communication is sent to the EMS that includes one or more unique ESP account IDs that the ESP personnel or their respective ESP is currently subscribed to.

### Emergency Response Environment

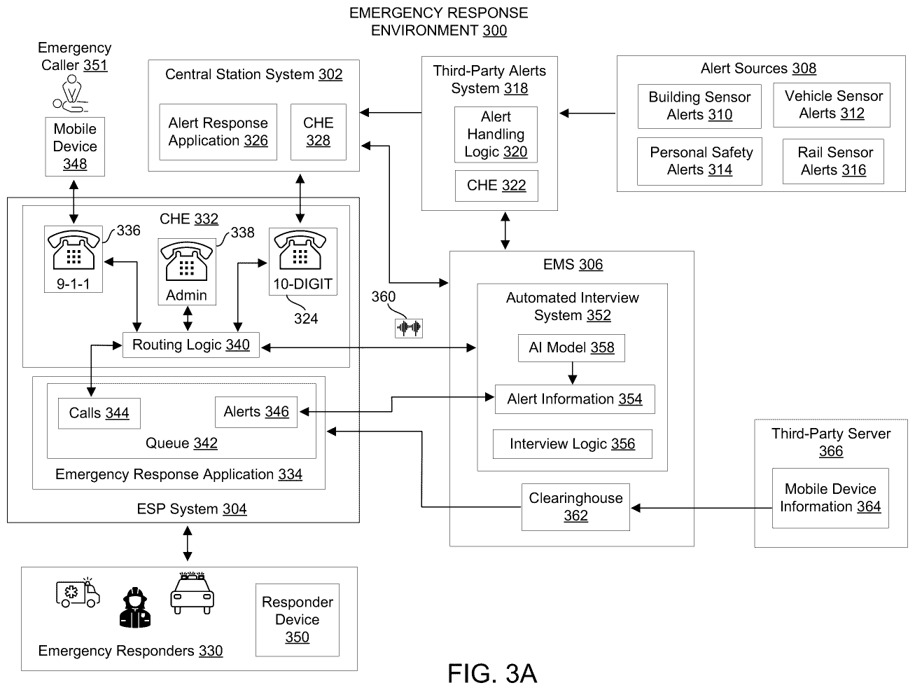

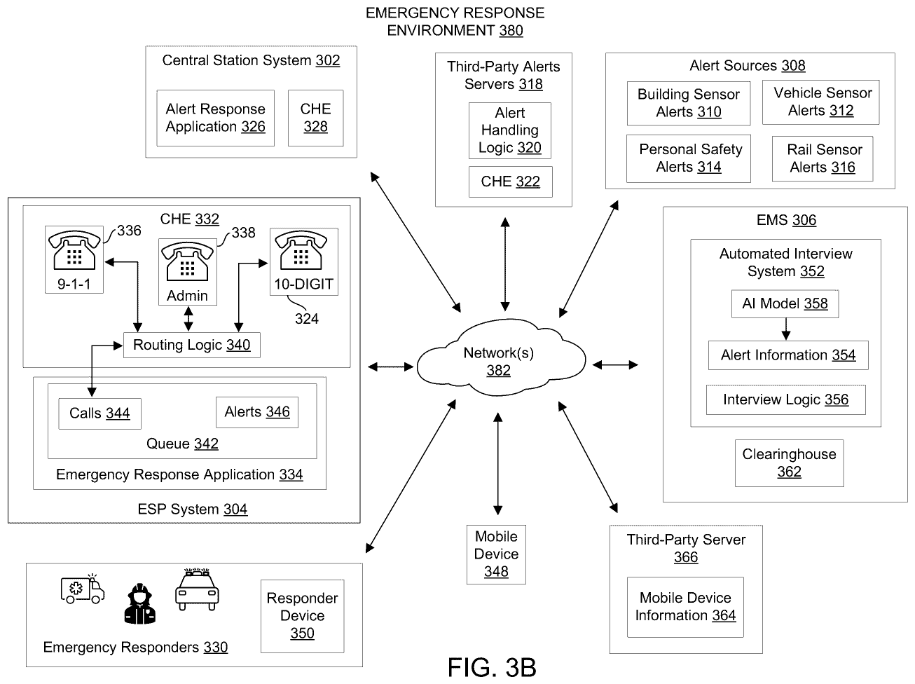

FIG. 3A illustrates a diagram of an emergency response environment 300 configured to provide automated alarm intake and classification for an ESP, in accordance with aspects of the disclosure. The automated alarm intake and classification is based on an automated interview system in an EMS, and the automated interview system is configured to reduce errors in address taking (e.g., disambiguate/validate addresses), enable a dispatcher to continue addressing other emergencies while the alarm information is being collected, and reduce the time and labor associated with manual intaking and transcribing a call to a 10-digit line (e.g., to a non-emergency or dedicated alarm line), according to embodiments of the disclosure. Advantageously, the techniques disclosed herein may address and may at least partially solve problems that ESPs (e.g., PSAPS) struggle with due to under-staffed ESPs or due to very high call volume. The emergency response environment 300 includes a central station system 302, an ESP system 304, and an EMS 306 configured to facilitate dispatching emergency responders to alarm callers and/or sensor alarms, according to an embodiment.

Central station system 302 may receive notification of sensor alerts or alarms that can be triggered from one or more of a number of alert sources 308. Central station system 302 is an example implementation of central station system 160 (shown in FIG. 1C), according to an embodiment. Some of alert sources 308 include building sensor alerts 310, vehicle sensor alerts 312, personal safety alerts 314, and rail sensor alerts 316, according to an embodiment. Each of the alert sources 308 may be associated with one or more alert types, such as fire, vehicle accident, flooding, smoke, gas leak, train crash, broken window, or unauthorized entry (e.g., building, vehicle, train, etc.). Alert sources 308 may be associated with various sensor types. The sensor types may include, but are not limited to, a temperature sensor, a carbon monoxide (or other gas) sensor, a smoke detector, a shock sensor, a proximity sensor, a moisture detector, a motion detector, a bank alarm, an airbag deployment sensor, a heart rate sensor, a blood pressure sensor, a blood oxygen sensor, and the like.

Central station system 302 may directly or indirectly receive sensor alerts, in accordance with aspects of the disclosure. Alert sources 308 may include networked equipment (e.g., smart home device) that sends sensor alert data directly to central monitoring station 302, in some embodiments. Alert sources 308 may be configured to use satellite communications, Internet connectivity, mobile networks, or a combination thereof to provide an alarm notification or a sensor alert to third-party alerts system 318, in an embodiment. Third-party alerts system 318 may be associated with a manufacturer of one or more sensors used by alert sources 308, in an embodiment. Third-party alerts system 318 may include alert handling logic 320 and call handling equipment (CHE) 322. Alert handling logic 320 may be configured to forward a sensor alert to a particular one of a number of central stations (e.g., central station system 302) using, for example, geography-based assignments or information stored in a table or other data structure, for example. CHE 322 may be used by a telecommunicator of a third-party alerts company to call a 10-digit line 324 of ESP System 304 to report the sensor alert, according to one embodiment.

Central station system 302 may be configured to manage sensor alerts from a number of alert sources 308 and from a number of third-party alerts systems (e.g., third-party alerts system 318), according to an embodiment. Central station system 302 may include an alert response application 326 and CHE 328, in accordance with aspects of the disclosure. Alert response application 326 may include a number of instructions stored in a computer-readable memory that, when executed by a processor, may include a data structure that stores sensor alerts and a user interface that displays information related to a sensor alert. The sensor alert data may include, but is not limited to, alert type (e.g., fire, flood, etc.), sensor manufacturer, time of alert, address of alert, GPS coordinates of alert, a business name associated with the alert, a phone number for the premises of the alert, a point of contact for the premises (e.g., home owner), a zone/area of the alert within the premises, a train car number, a vehicle model, vehicle occupant count, vehicle occupant personal/medical information, driver name, driver telephone number, deliverer name, deliverer telephone number, and/or order delivery, for example. In response to receiving a sensor alert, a staff member or telecommunicator of the central station may use CHE 328 to call one or more phone numbers that are associated with the address or name of the source of the alarm. As one example, the telecommunicator may call a food or parcel deliverer in response to receipt of one of the personal safety alerts 314 that may be triggered by the delivery person pressing a button (e.g., on an app). As another example, the telecommunicator may reach out to a business owner, a homeowner, security personnel for a business, the person who triggered a personal safety alert, an associated family member, or the like. The telecommunicator may attempt to call to verify the sensor alert and may also use CHE 328 to call 10-digit line 324 of ESP system 304 to request emergency responders 330 to the location of the sensor alert.

ESP system 304 may include one, two, or more call lines that are available and used to provide assistance for emergency and non-emergency calls. ESP system 304 is an example implementation of ESP system 130, according to an embodiment. ESP system 304 includes CHE 332 and emergency response application 334, according to an embodiment. CHE 332 is an example implementation of audio system 134 (shown in FIG. 1B) and emergency response application 334 is an example implementation of emergency response application 139 (shown in FIG. 1B), according to an embodiment. CHE 332 may include 10-digit line 324, an emergency line 336 (e.g., 9-1-1), an admin line 338, and routing logic 340. Emergency line 336 is an emergency call line that may be used to answer 9-1-1 calls, 10-digit line 324 may be used to receive alarm-based calls from a central station or other monitoring agency, and admin line 338 may be used to for general administrative calls such as non-emergency information requests.

Emergency response application 334 receives and displays information from multiple ESP system telephone lines, in accordance with aspects of the disclosure. Emergency response application 334 may include a queue 342 that is configured to display calls 344 and alerts 346. Calls 344 may include digital representations of emergency calls made to emergency line 336 and may include a telephone number of mobile device 348 (e.g., the device used to place the emergency call), a location of the call, a name of emergency caller 351, a type of emergency (e.g., fire, vehicle accident, burglary, battery, etc.), for example. Information for calls 344 may be at least partially populated from ANI/ALI (Automatic Number Identification/Automatic Location Identification) data and/or may be populated with supplemental mobile device information 364 obtained from EMS 306. Information for calls 344 may be routed to emergency response application 334 using routing logic 340 of CHE 332. Emergency response application 334 may be a web-based application that is hosted and/or provided by EMS 306. Routing logic 340 may include various communication electronics that converts audio and call data to a digital format and that routes that data to emergency response application 334 (e.g., a CAD application) for display, for example. A telecommunicator using ESP system 304 for the ESP may dispatch emergency responders 330 by calling or electronically sending a dispatch request to a responder device 350 to respond to calls 344 and/or alerts 346, according to an embodiment.

Alerts 346 include various information about alerts, sensor alerts, and sensor alarms, in accordance with aspects of the disclosure. Alerts 346 may include and display information relating to sensor alerts as well as information collected from a telecommunicator at a central station. For example, alerts 346 may include, but is not limited to, alert type (e.g., fire, flood, etc.), sensor manufacturer, time of alert, address of alert, GPS coordinates of alert, a business name associated with the alert, a phone number for the premises of the alert, a point of contact for the premises (e.g., home owner), a zone/area of the alert within the premises, a train car number, a vehicle model, vehicle occupant count, vehicle occupant personal/medical information, order delivery, alarm verification attempts, notes from the telecommunicator (e.g., a summary of actions taken by central station to verify the alert), and/or a central station operator number or telecommunicator ID.

Alerts 346 may be automatedly populated into queue 342 by EMS 306, in response to entry of an alert in alert response application 326, according to an embodiment. In one embodiment, alert response application 326 provides alerts directly to emergency response application 334 from central station system 302 through one or more alert services (e.g., an alert sharing service) provided by EMS 306. For example, alert response application 326 may have an active web connection (e.g., a webhook or other event-based connection) with EMS 306 that pushes new alerts from central station system 302 to EMS 306. EMS 306 may then push the new alerts to emergency response application 334 using another active web connection, for example.

Alerts 346 are populated into queue 342 by EMS 306, in response to a call made to 10-digit line 324 from central station system 302, in accordance with aspects of the disclosure. In one embodiment, routing logic 340 may be configured (e.g., using call-forwarding, a software redirection process, etc.) to forward calls to the 10-digit line 324 to EMS 306 for automated transcription and conversion into alerts 346. ESP or PSAP staff (e.g., telecommunicators) are under-resourced agencies that manually answer calls, de-duplicate calls for a singular incident, and deprioritize calls that are unnecessarily made to emergency line 336. On top of these responsibilities, ESP staff are concurrently responsible for handling (e.g., dispatch, dismiss, report, etc.) calls made to the 10-digit line 324. However, some of the calls made to the non-emergency 10-digit line can be higher priority (e.g., a fire alarm alert) and some can be potentially lower priority (e.g., a proximity alert outside of a premise). Problematically, gathering information from calls made to 10-digit line 324 is a manual process (not integrated into dispatcher CAD (computer-aided dispatch) systems) and is typically handled by taking notes that are subsequently entered into a computing system. During this process, premise addresses may be miscommunicated or misspelled, which may lead to delayed dispatch for the alert or alarm source. Additionally, verification can be difficult to perform, and street names may be misspelled.

Advantageously, EMS 306 is configured to use an automated interview system 352 to receive 10-digit line calls, extract alert data 354 from the call, verify alert data 354 (e.g., premise address) during the call, and provide alert data 354 to ESP system 304 to populate alerts 346 for ESP telecommunicators/dispatchers, in accordance with aspects of the disclosure. EMS 306 is an example implementation of EMS 120 (shown in FIG. 1A), according to an embodiment. Automated interview system 352 includes interview logic 356 and an AI model 358 to generate alert data 354 for ESP system 304, in accordance with aspects of the disclosure. Alert data 354 is data or alert data that is representative of information provided to a dispatcher to enable the dispatcher to determine what type of emergency responder to request. Automated interview system 352 and interview logic 356 operate on audio data 360 received from central station system 302 and provides prompts through audio data 360 to obtain and verify alert data 354, according to an embodiment. Automated interview system 352 receives call audio data 360 and runs at least part of the call audio data 360 through AI model 358. Applying the audio data 360 to AI model 358 enables automated interview system 352 to summarize responses in audio data 360, disambiguate response content (e.g., a mumbled or poorly worded address), and/or determine the subject or type of emergency, among other things. By automating and transcribing an interview with a telecommunicator of a central station, EMS 306 may increase the accuracy of location information provided during a 10-digit line call, determine the nature of the call, and confirm that the alarm has been verified while concurrently reducing the time and effort that is historically consumed through manually written verbal instructions from a central station.

EMS 306 may include a clearinghouse 362 to perform supplemental emergency data processing, in accordance with embodiments of the disclosure. Clearinghouse 362 may be configured to receive mobile device information 364 (e.g., supplemental emergency data) from a third-party server 366 (e.g., a server of a telecommunications company, of a mobile device manufacturer, and/or of a mobile device operating system developer) and provide the mobile device information 364 to emergency response application 334. Calls 344 may be updated to include supplemental emergency data (e.g., the mobile device information 364) that includes, for example, a caller's name, more accurate (e.g., satellite-based) location information, personal/medical information about the caller, or the like. Third-party server 366 may be similar to third-party server 265, according to an embodiment.

FIG. 3B illustrates a diagram of emergency response environment 380 that includes one or more networks 382, in accordance with aspects of the disclosure. One or more networks 382 may communicatively couple central station system 302, ESP system 304, EMS 306, third-party alerts system 318, third-party server 366, mobile device 348, alert sources 308, emergency responders 330, and responder device 350 together. One or more networks 382 may include wired (e.g., telephone) networks, wireless networks, Internet networks, intranet networks, voice over Internet protocol (VOIP) networks, Bluetooth networks, near-field communications (NFC networks), or WiFi networks, according to various implementations.

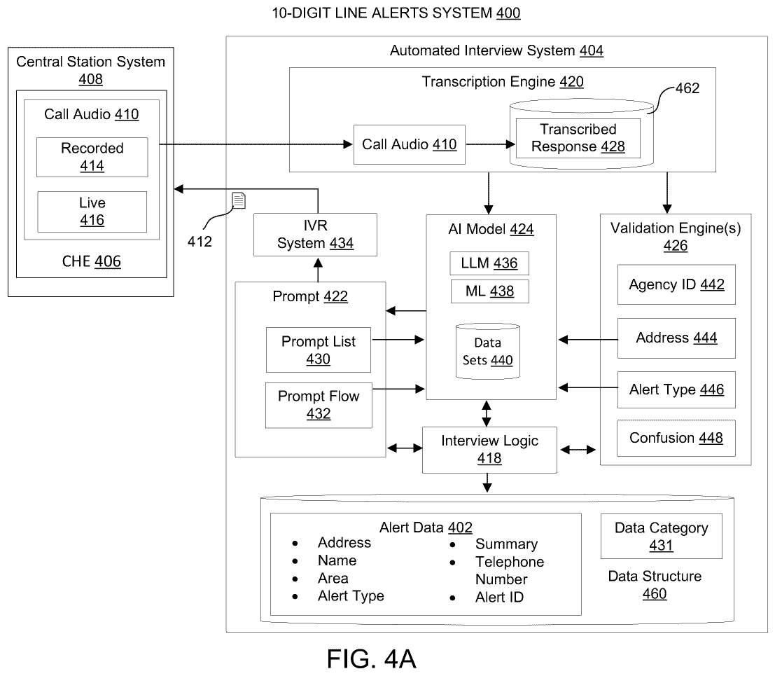

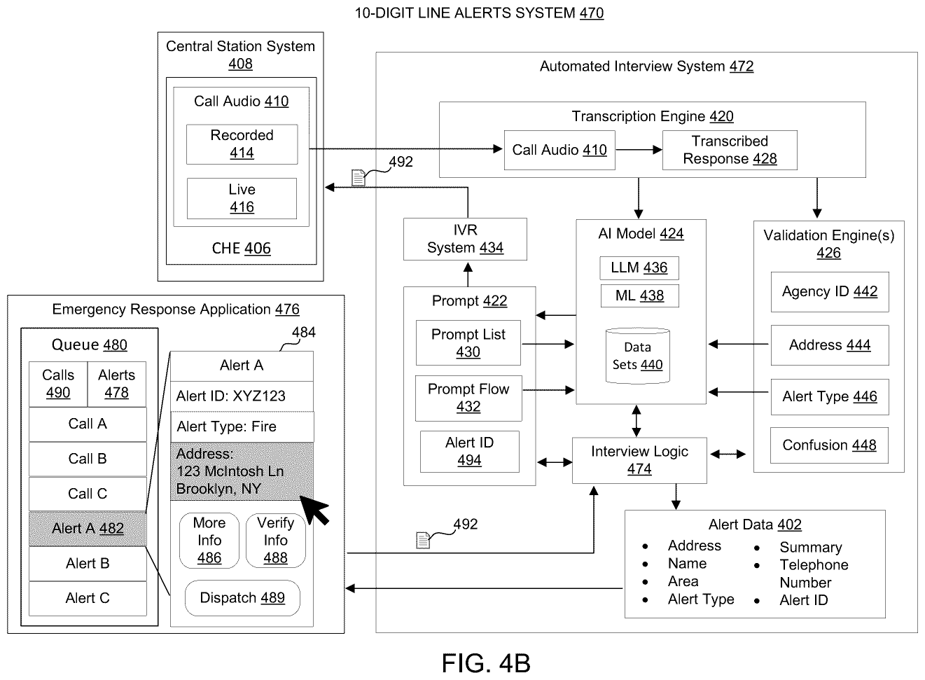

FIGS. 4A and 4B illustrate example diagrams of 10-digit line alert systems, in accordance with aspects of the disclosure. FIG. 4A illustrates a 10-digit line alerts system 400 that is configured to receive 10-digit line calls, transcribe the calls, determine content, at least partially validate content, and generate alert data 402 for use by an emergency response application, in accordance with aspects of the disclosure. 10-digit line alerts system 400 includes an automated interview system 404 that is configured to interact with CHE 406 of a central station system 408, according to an embodiment. In particular, automated interview system 404 is configured to receive and operate on call audio 410 and transform call audio 410 into alert data 402. In accordance with various embodiments of the disclosure, automated interview system 404 may be responsive to recorded call audio 414 (e.g., 5-10 second segments), live call audio 416, or a combination of recorded call audio 414 and live call audio 416. Segments of live call audio 416 may be recorded by automated interview system 404 to generate segments of recorded call audio 414 that are transcribed by transcription engine 420.

Automated interview system 404 includes a number of components that may be configured to operate together to transform call audio 410 into alert data 402, according to an embodiment. Automated interview system 404 includes interview logic 418, a transcription engine 420, a prompt 422, an AI model 424, and validation engines 426, according to an embodiment. Interview logic 418 includes one or more processes or algorithms that determine a flow of operations for providing prompt 422, for applying a transcribed response 428 to AI model 424, and/or for applying a transcribed response data to validation engines 426, according to an embodiment.

Automated interview system 404 and/or interview logic 418 may be configured to provide prompt 422 to central station system 408 at least partially based on a prompt list 430 and a prompt flow 432. Prompt list 430 may include a list of questions and statements that may be combined with portions of transcribed response 428 to generate prompt 422, according to an embodiment. For example, if transcribed response 428 includes “433 Hershey Avenue”, prompt 422 may be a confirmation prompt that includes “Please confirm that the address is 433 Hershey Avenue,” for example. Illustrative examples of questions/statements that may be included in prompt list 430 may include, but are not limited to: “How can I help you today?”, “What is the nature of your call?”, “Are you calling about a new alert?”, “What is the address of the premises?”, “What is your agency ID?”, “Is this the correct address?”, “Do you have a room/apartment number for this alert?”, “We are unable to validate that address-will you please repeat the address?”, “How many times did you attempt to verify the alert?”, “Did you verify the alert?”, “Please tell me the steps you took to verify the alarm”, “Do you know how many cars were derailed during the train accident?”, “What is the manufacturer of the sensor?”, “How many vehicles were involved in the accident?”, “Is anyone hurt in the car accident?”, “How many occupants are in the vehicle?”, “What time was the alarm/alert received?”, for example. Automated interview system 404 may apply text-based prompt 422 to interactive voice response (IVR) system 434 to generate call audio 412 that is delivered to CHE 406 for further response by the telecommunicator at the central station.

Prompt flow 432 may include an order and/or a priority of prompt list 430 that may or may not be based on the nature or type of alert. For example, prompt flow 432 may define an order of presentation of prompts in prompt list 430. An example order of presentation may include first: address, second: alert type, third: point of contact name, fourth: summary of the alert, and fifth: a telephone number for a point of contact, for example. Interview logic 418 may alter prompt flow 432 if portions of alert data 402 are provided out of order. For example, if the third alert data parameter (e.g., point of contact name) is provided before the first alert data parameter (e.g., address), then interview logic 418 may add the out of order response to data structure 460 and continue through prompt list 430 by providing the next highest priority prompt that does not have a response (e.g., by returning back to the unanswered first prompt).

Automated interview system 404 is configured to use AI model 424 to determine, summarize, and/or interpret an intended meaning of transcribed response 428 that is received in response to prompt 422, according to an embodiment. For example, each time transcribed response 428 is received, automated interview system 404 may selectively provide transcribed response 428 to AI model 424 with a prompt such as “Summarize this”, “What addresses this?”, and/or “What is the nature of the call based on this response?”. AI model 424 may include one or more large language models (LLM) 436, one or more machine learning (ML) models 438, and may be at least partially trained on one or more data sets 440, according to an embodiment. LLM 436 and/or ML model 438 may include commercially available generative pre-trained transformers (GPTs) (e.g., by OpenAI, Google, Microsoft, etc.) or other AI models that can be at least partially trained on context specific data sets (e.g., data sets 440), according to one embodiment. Data sets 440 may include questions, responses, recordings, descriptions, documentation, technical manuals, training manuals that are used by, that have been used by, or that are otherwise associated with operators or managers of central station system 408 (e.g., a railroad ECC, a merchant-specific monitoring agency, etc.). In one embodiment, prompt list 430 and/or prompt flow 432 are provided to AI model 424 as part of data sets 440, and automated interview system 404 prompts AI model 424 to generatively provide a subsequent prompt 422 based on transcribed response 428, according to an embodiment. An example prompt to AI model 424 might include “You are a PSAP telecommunicator responding to a call from a monitoring agent, please provide a sequence of prompts or questions to acquire the alert data needed for a PSAP telecommunicator to dispatch the call to emergency responders.”

Automated interview system 404 uses validation engines 426 to selectively verify or validate information provided in transcribed response 428, in accordance with aspects of the disclosure. Validation engines 426 are at least partially used in transforming transcribed response 428 (i.e., response data) into alert data 402, according to an embodiment. The integration of one or more validation engines into the discloses systems, processes, and algorithms improves the ECC computing systems by reducing time and errors associated with dispatcher manual transcription and data entry of non-emergency calls. If any alert data 402 fails a validation test, additional prompts may be provided to the central station telecommunicator until invalidity issues (e.g., invalid agency ID, non-dispatchable address, invalid alert type, etc.). Validation engines 426 may be configured to validate agency ID 442, an address 444, an alert type 446, and/or a level of confusion 448 of the telecommunicator, according to an embodiment. Validation engines 426 may include a list of agency IDs and may be configured to check the list of agency IDs to verify that agency ID 442 is included in the list of agency IDs, according to an embodiment. In one embodiment, validation engines 426 include text search code/script that searches an existing list of agency IDs to confirm whether a received agency ID is in the list. In one embodiment, interview logic 418 provides a prompt to AI model 424 that includes “Does the response include an agency ID that is in the following list of agency IDs.” In one embodiment, validation engines 426 leverage AI model 424 to partially verify or validate agency ID 442. Validation engines 426 may use one or more address validation tools or engines to verify and/or validate address 444, according to an embodiment. For example, validation engines 426 may include a commercially available address validation service (e.g., Address Validation API by Google) that provides API through which address 444 can be provided to and validated by the service, according to an embodiment. If the address validation service determines that address 444 is invalid or ambiguous, validation engines 426 may provide the invalid address notification to interview logic 418 and/or to AI model 424 to generate prompt 422 to re-acquire address 444 from the telecommunicator (e.g., from central station system 408). Re-prompting the telecommunicator may include phrases such as “Please repeat the street name”, “Please spell the address”, and/or “Please repeat the address”. Validation engines 426 may validate alert type 446 by comparing (e.g., performing a text-based search) alert type 446 to a list of predetermined alerts, according to an embodiment. Validation engines 426 may provide transcribed response 428 to AI model 424 with a prompt of “What type of alert is this?”, according to an embodiment. Validation engines 426 may determine a level of confusion 448 of the telecommunicator. If a level of confusion 448 of the telecommunicator is above a threshold (e.g., 5/10), automated interview system 404 may be configured to provide prompt 422 to ask the telecommunicator if he/she is confused about something, for example. To determine a level of confusion 448, interview logic 418 may provide a prompt to AI model 424 that includes something like “On a scale of 1 to 10, how confused does a caller sound from the following response.” If it is determined that the user is confused, prompt 422 may be repeated or modified (e.g., generatively by AI model 424) and re-delivered, according to an embodiment.

10-digit line alerts system 400 may include data structures 460 and 462 to store and/or associate various types of data, in accordance with aspects of the disclosure. Data structure 462 may include a data store, a database, a buffer or the like to store response data that represents transcribed response 428. Data structure 460 may be used to store and associate alert data 402 and data category 431 (or data type), according to an embodiment. Alert data 402 includes data that is extracted from call audio 410 and that is transformed from transcribed response 428 (e.g., response data) through, for example, AI model 424, interview logic 418, and/or validation engines 426, according to an embodiment. Data structure 460 may include a database, a table, or other structure that associates a data category 431 (e.g., address, name, area, alert type) with alert data 402 (e.g., particular values for address, name, area, alert type, etc.). As illustrated in FIG. 3A, alert data 402 (e.g., referenced as alert data 354) may be provided to an emergency response application and may be used to at least partially populate dispatchable alerts that are displayed and managed by the emergency response application, according to an embodiment.

FIG. 4B illustrates a diagram of 10-digit line alerts system 470 that is configured to provide live updates to alerts while the automated interview system interviews a telecommunicator, in accordance with aspects of the disclosure. 10-digit line alerts system 470 includes an automated interview system 472 that includes interview logic 474 that is configured to or operable to update an emergency response application 476 incrementally with portions of alert data 402, according to an embodiment. For example, automated interview system 472 and/or interview logic 474 may be configured to generate an alert ID and transmit partially acquired alert data 402 once, for example, an address and an alert type (e.g., fire alarm, car accident) has been determined from call audio 410. Automated interview system 472 and/or interview logic 474 may be configured to generate an alert ID and transmit partially acquired alert data 402 to emergency response application 476 once two or more alert properties or values (e.g., address and alert type) in alert data 402 have been determined from call audio 410, according to an embodiment.

Automated interview system 472 is configured to update alerts 478 of a queue 480 with partial alert data 402, according to an embodiment. Queue 480 may be displayed in emergency response application 476 and may display alerts 478 and calls 490. The user interface for queue 480 may include tabs that enable toggling between displaying alerts 478 and calls 490, or alerts 478 and calls 490 may be concurrently displayed, according to various embodiments of the disclosure. If a user clicks on one of the alerts 478 (e.g., alert 482), a window 484 may be displayed with partial or incomplete alert data 402. In one embodiment, complete alert data 402 includes 5-10 alert parameters/categories whereas incomplete alert data 402 includes 2-3 alert parameters/categories, for example. An example of partial alert data 402 may include an alert ID, an alert type, and an address. An advantage of providing and displaying partial alert data 402 is that a telecommunicator may begin dispatching the alert to first responders while automated interview system 472 continues collecting and verifying alert data 402 from central station system 408. Window 484 may include user interface options that enable an ESP user (e.g., a telecommunicator) to interact with the partial alert data. For example, window 484 may display additional UI elements in response to a user clicking or otherwise selecting a parameter (e.g., address) of alert 482. In one embodiment, in response to selection of an alert parameter (e.g., address), window 484 may display selection buttons (e.g., more information button 486, verify information button 488) to enable the user to get specific additional information from the ESP telecommunicator during the automated interview. In one embodiment, when alert 482 is selected a dispatch button 489 is provided in window 484 to allow a dispatcher to dispatch (e.g., electronically or verbally contact emergency responders). In response to a request for additional information, automated interview system 472 may receive a request 492, convert the request into a prompt (e.g., using AI model 424), and provide the request 492 with alert ID 494 to central station system 408 (e.g., by calling CHE 406 and providing the information with IVR system 434).

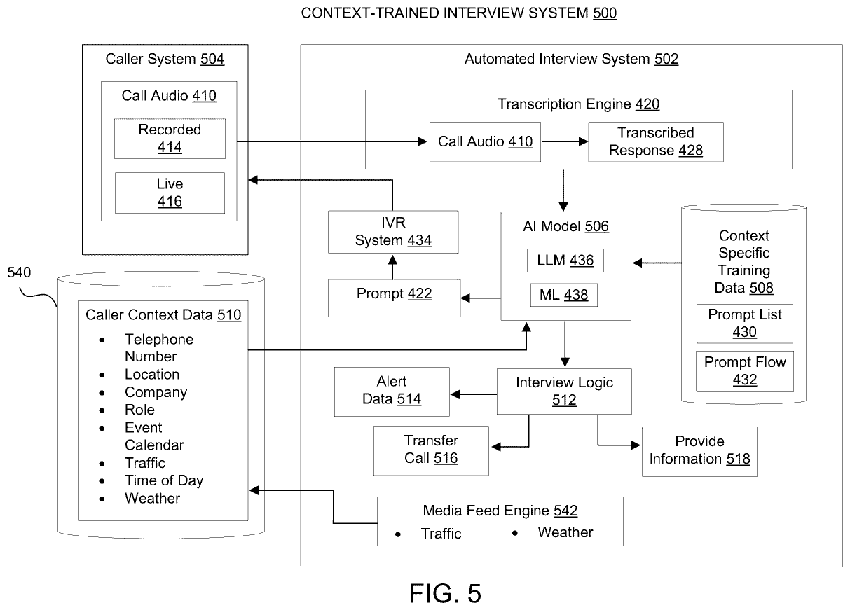

FIG. 5 illustrates a diagram of a context-trained interview system 500 that is configured to automate, transcribe, and validate portions of an interview for a call center that is related to alarms, alerts, and/or emergencies, in accordance with aspects of the disclosure. Context-trained interview system 500 is operable to transform context-specific training data 508 and caller context data 510 into alert data or an operation (e.g., transfer a call or provide responsive information), according to an embodiment. A call center may include an emergency call center (ECC), a third-party alert company/system, a central station (e.g., an alert monitoring station that receives alerts from a number of third-party alert companies/sensors), a central station system, an ESP (e.g., a rail-related ESP, an 9-1-1 ESP, etc.), and/or an ESP system, according to embodiments. Context-trained interview system 500 may be incorporated into one or more systems in emergency response environment 300. Context-trained interview system 500 includes automated interview system 502 configured to automate an interview with caller system 504 (e.g., a mobile phone, CHE, a landline, etc.).

Automated interview system 502 includes an AI model 506, context-specific training data 508, caller context data 510, and interview logic 512 configured to operate together to classify, manage, or otherwise handle a call from caller system 504, according to an embodiment. AI model 506 is trained with context-specific training data 508 that is specific to the context or environment that automated interview system 502 is implemented. For example, if automated interview system 502 is implemented for a rail-based ESP, prompt list 430 and prompt flow 432 may be populated based on the information requested and used by a rail-based ESP. Example prompts may include, “What did you see?”, “What is the location of the railroad track you are calling about?”, “Has there been a derailment?”, “Can you tell how many cars have been derailed?”, “Can you see the name of the train?”, “What is the nature of your call?”, “What city are you calling from?”, and “What road or cross-section is closest to you?” As another example, if automated interview system 502 is implemented for a food delivery-based call center, prompt list 430 and prompt flow 432 may be populated based on the information requested and used by a food delivery-based call center. Example prompts may include, “Are you okay?”, “Have you been in an accident?”, “Do you feel unsafe?”, “Are you lost?”, “Is there a problem with the deliver address?”, “Are you stuck in traffic or road construction?”

By training AI model 506 with context-specific training data 508, AI model 506 may be configured to provide prompt 422 based on transcribed response 428. Automated interview system 502 and/or interview logic 512 may be configured to rely on AI model 506 to generate prompt 422 based on the context or operating environment. In one embodiment, interview logic 512 prompts AI model 506 with something like, “You are a call center operator for a railway ECC, please respond to the following transcribed audio.” AI model 506 may then autonomously loop through various prompts and responses until a particular action is performed, for example, by interview logic 512.

Automated interview system 502 may also use caller context data 510 to interpret transcribed response 428 and to generate content for prompt 422, in accordance with aspects of the disclosure. Caller context data 510 may include, but is not limited to, a telephone number, a location, a company associated with the telephone number, a caller's role, nearby events, an event calendar, traffic patterns, live traffic updates, time of day, weather, holidays, age of caller, or the like. Caller context data 510 may be stored in a data structure 540 that associates a particular caller with caller context data 510, according to an embodiment. For example, parameters/categories of caller context data 510 (e.g., location, time of day, weather) may be associated with a caller ID (e.g., telephone number, name, etc.) in data structure 540. Automated interview system 502 may include a media feed engine 542 that collects information from media feeds for traffic and/or weather based on a location of a caller, for example. If automated interview system 502 receives a traffic feed that indicates a car accident in an approximate location of a caller, AI model 506 may prioritize prompts related to confirming that the nature of the call is to report a car accident, for example. As another example, if automated interview system 502 receives a particular weather report, an event calendar, and a location of a caller, AI model 506 may prioritize prompts related to a combination of an event and weather (e.g., heat stroke for a runner). Automated interview system 502 may receive or pull caller context data 510 from one or more third-party servers (e.g., third-party server 366 shown in FIG. 3A) that provide supplemental mobile device information.

Based on transcribed response 428, interview logic 512 may be configured to perform one or more of a number of actions to handle a call. Interview logic 512 may be configured to generate and provide alert data 514, perform a call transfer 516, and/or provide information 518, according to an embodiment. Call transfer 516 might be to another n11 number, such as to 2-1-1 (community services), 3-1-1 (non-emergency municipal services), 4-1-1 (e.g., directory assistance), 5-1-1 (traffic information), 6-1-1 (e.g., telecommunications/phone issues), 7-1-1 (hearing impairment line), 8-1-1 (underground utilities), or 9-8-8 (e.g., suicide hotline/lifeline), for example. Provide information 518 may include providing reasons why a road is closed, providing a telephone number to call, indicating dates or road construction or road closures, providing directions to the nearest hospital or police stations, providing information for resolving a citation (e.g., a moving violation citation), receiving and logging a complaint, and the like. In one embodiment, interview logic 512 and/or AI model 506 provides prompt 422 to caller system 504 to confirm that the call or issues have been resolved prior to terminating the call.

Context-trained interview system 500 may be configured to handle calls to an admin line for an ESP (e.g., admin line 338 shown in FIG. 3A), in accordance with aspects of the disclosure. Context-trained interview system 500 may be integrated into emergency response environment 300 and/or into EMS 306 (shown in FIG. 3A), and context-trained interview system 500 may be configured to receive and response to call audio from admin line 338 (e.g., routed from routing logic 340), according to an embodiment. Context-specific training data 508 may be trained on pools of questions, responses, statements, requests, and actions taken in response to a call to an admin line of an ESP such as a 911 call center. Context-specific training data 508 may also include standard operating procedure manuals, training manuals, and best practices guides to enable AI model 506 to respond appropriately for the ESP that is being represented. In one embodiment, calls handled by context-trained interview system 500 may be recorded and analyzed by people, for the purpose of further training (e.g., fine-tuning) AI model 506 with feedback on handled calls.

In one embodiment, context-trained interview system 500 incorporates one or more features of 10-digit line alerts systems 400 and/or 470 to support handling calls of an admin line of a ESP. For example, interview logic 512 may at least partially be configured to generate prompt 422 based on a prompt list 430 and/or a prompt flow 432, rather than relying on AI model 506 to determine prompt 422 based on context-specific training data 508, according to an embodiment of the disclosure.

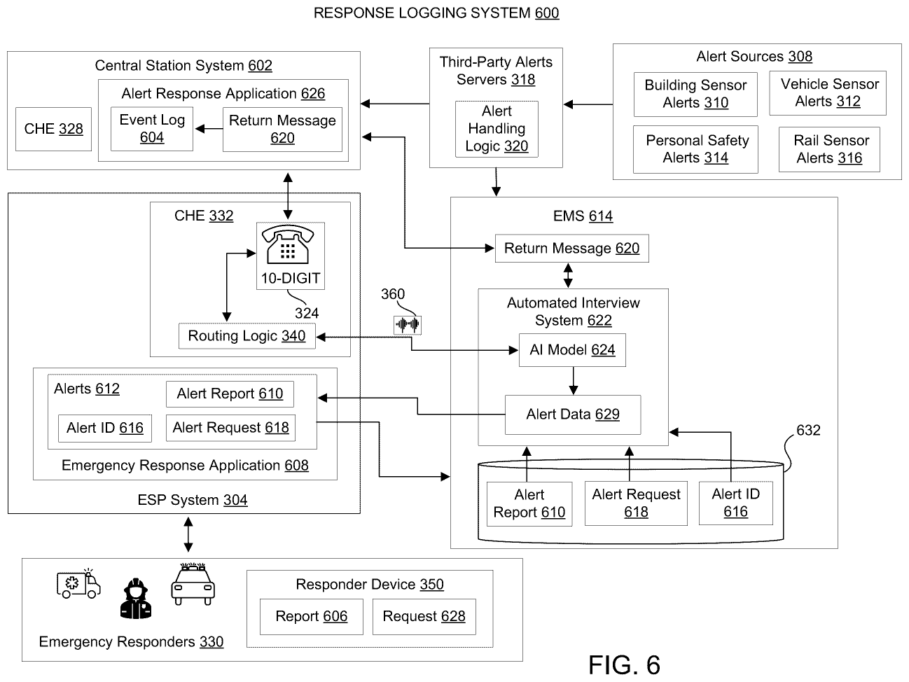

FIG. 6 illustrates a diagram of a response logging system 600 that is configured to improve operations of a central station (a.k.a., a monitoring agency) by enabling a central station system 602 to determine various metrics for calls made to an ESP, in accordance with aspects of the disclosure. Response logging system 600 may include the operational capabilities of one or more other systems disclosed herein (e.g., emergency response environment 300), in accordance with aspects of the disclosure. For operators or managers of one or more central stations, it may be beneficial to understand how long it typically takes for an ECC to dispatch an alert from alert sources 308. It may also be beneficial to understand how long it typically takes for emergency responders 330 to arrive at, close, or otherwise respond to alert sources 308. For example, with response time metrics, operators or managers of a central station can improve staff training, determine needed staff quantities, inform customers of average response times, advertise services, invest in equipment, or otherwise improve the use of central station system 602.

Central station system 602 maintains and/or updates an event log 604 based on outcome reports provided by emergency responders 330 and/or ESP system 304, according to an embodiment. Event log 604 is a data structure that associates received alerts, with dispatch status, and/or emergency responder actions taken. A dispatcher operating emergency response application 608 may generate an alert report 610 to update the dispatch status (e.g., received, queued, waiting, closed, dispatched, etc.) of alerts 612 received from EMS 614, according to an embodiment. Alert report 610 may be pushed or pulled from emergency response application 608 for receipt by EMS 614. Emergency responders 330 may use responder device 350 to call, write, or otherwise deliver a report 606 of response to an alert. An ESP telecommunicator may update an emergency response application 608 with an alert report 610 that is based on report 606. Emergency response application 608 may be configured to manage and graphically display a number of alerts 612 that have been received from EMS 614 or manually entered into emergency response application 608. With alerts 612, emergency response application 608 may display alert data (e.g., address, alert type, etc.), alert report 610, alert ID 616, and an alert request 618. In response to receiving and/or generating alert report 610, emergency response application 608 may push alert report 610 to EMS 614 or EMS 614 may be configured to detect (e.g., using an event) the addition of alert report 610.

EMS 614 provides alert report 610 to central station system 602 using a return message 620, according to an embodiment. Return message 620 may be generated by automated interview system 622 using, for example, AI model 624. Automated interview system 622 may be configured to provide alert report 610 to AI model 624 with a prompt such as “Generate a message for an alarm call center to report out the following alert report,” to generate return message 620, according to an embodiment. Automated interview system 622 may include alert ID 616 in return message 620 to enable central station system 602 to pair a particular alert report with a particular alert that has been called in. EMS 614 may be configured to email or otherwise electronically transmit return message 620 to central station system 602 (e.g., to alert response application 626), according to one embodiment. EMS 614 may have an established (e.g., WebSocket) connection with alert response application 626 and may be configured to push return message 620 into alert response application 626. In one embodiment, in response to receiving alert report 610 from emergency response application 608, EMS 614 is configured to use automated interview system 622 to call CHE 328 and use IVR to provide return message 620 to a telecommunicator using central station system 602. Alert response application 626 may integrate content from return message 620 into event log 604 to enable central station system 602 to generate metrics (e.g., response time metrics) that measure, for example, the time from calling 10-digit line 324 until the time emergency responders 330 arrive at a premises of a source of an alert, according to an embodiment.

Response logging system 600 is configured to enable requests for more information from a central station, according to an embodiment. Emergency responders 330 may use responder device 350 to make a request 628 for more information related to a particular alert (e.g., alert ID 616). Request 628 may include a specific message, a request for an address, a request for personal information of people associated with an alarm or alert, or the like. Responder device 350 may be configured to transmit request 628 to ESP system 304 or to EMS 614. ESP system 304 may receive request 628 and use request 628 to populate alert request 618. EMS 614 may independently generate alert request 618 based on additional information requested by an ECC dispatcher. EMS 614 may use alert request 618 to form content for return message 620 which may be electronically sent to alert response application 626 or which may be audibly provided to a telecommunicator by calling a telephone number to CHE 328, according to an embodiment. In response to return message 620, automated interview system 622 and/or EMS 614 may generate alert data 629 that is provided to emergency response application 608 and/or responder device 350 to reply to alert request 618 and/or request 628, according to an embodiment. EMS 614 may include a data structure 632 that stores and/or associates alert report 610, alert request 618, and/or return message 620 with a particular alert ID 616. The data in data structure 632 may be transformed by operations of automated interview system into output (e.g., within event log 604) that substantially improves the operation of central station system 602 and generally improves the technology area of alarm response systems, according to an embodiment.

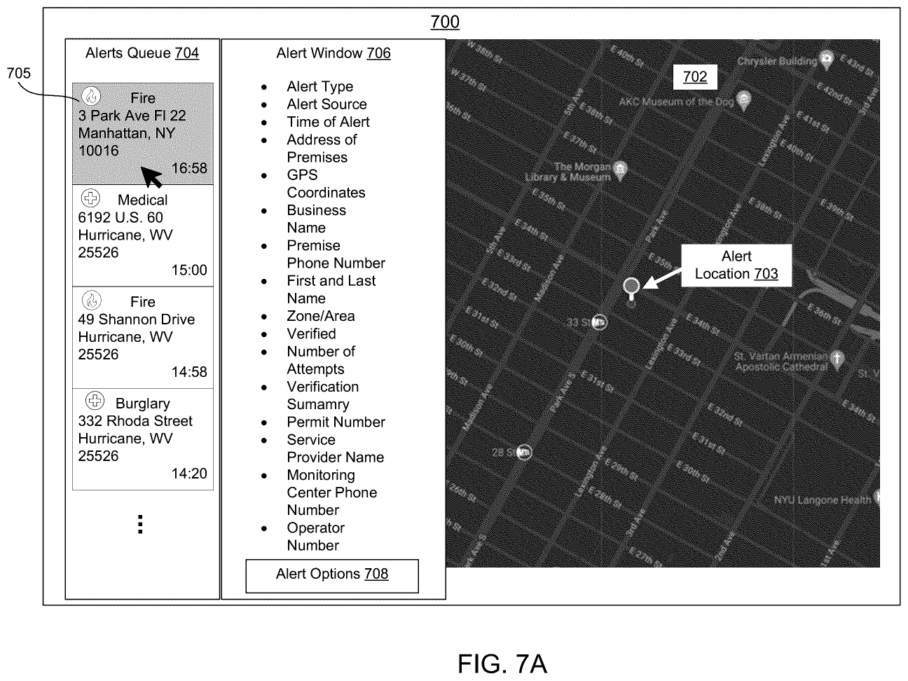

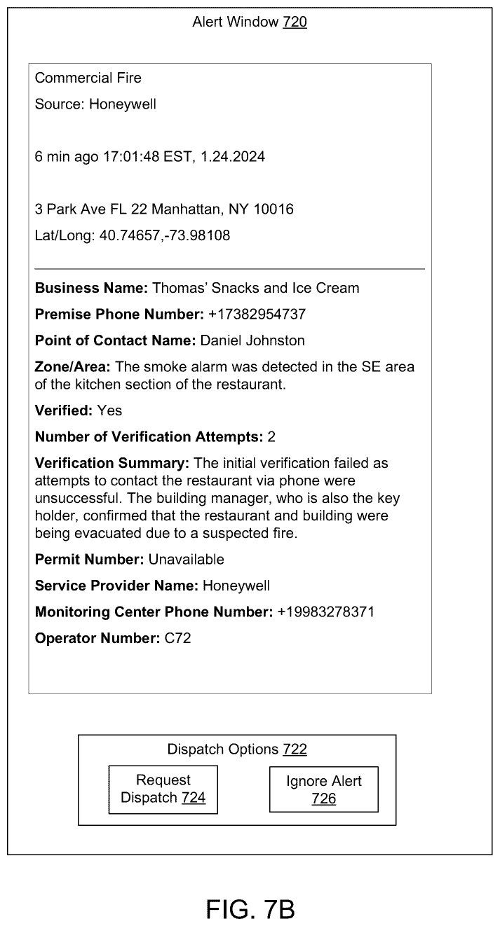

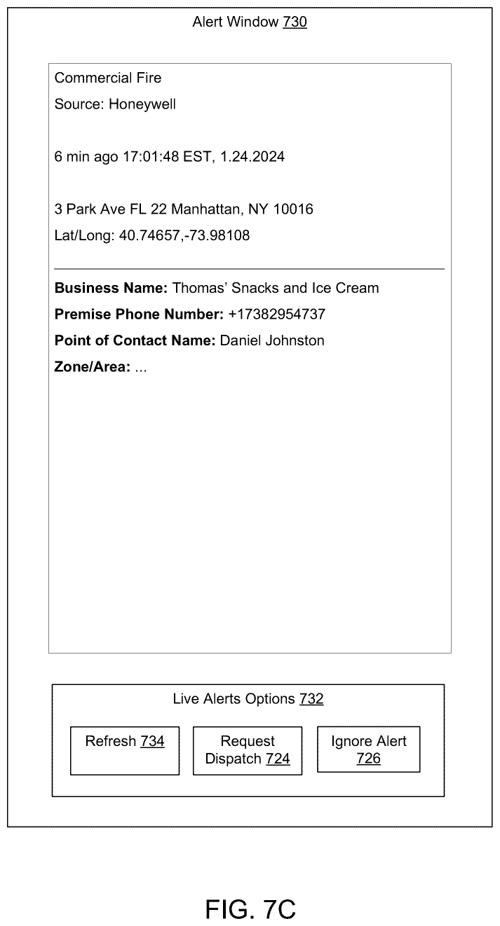

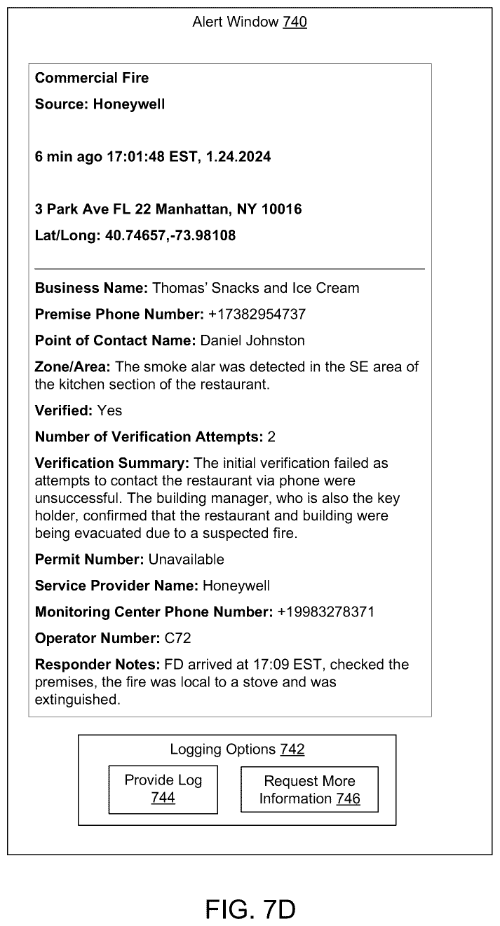

FIGS. 7A, 7B, 7C, and 7D illustrate different aspects of an emergency response application 700, in accordance with aspects of the disclosure. Emergency response application 700 may include a user interface that can be displayed on one or more computing devices at an ECC. An alert response application provided by a central station system may have similar features (e.g., an alert queue, a map, etc.) as emergency response application 700, according to an embodiment. The user interface may include a map 702, an alerts queue 704, and an alert window 706, according to an embodiment. Map 702 may include an alert location 703 and may include a number of landmarks to help a dispatcher/telecommunicator quickly gain orientation for alert location 703. Alerts queue 704 includes a number of alerts that are on display for ease of reference. Each alert in alerts queue 704 may indicate: whether the alert is commercial or residential, an address of the alert, the type of the alert (e.g., fire, medical, burglary, etc.), an elapsed time since notification since receipt of the alert, and the like. In response to clicking on a particular one of the alerts (e.g., alert 705), emergency response application 700 may be configured to display alert window 706. Alert window 706 includes various types of alert data (e.g., from a central station) that may be acquired and provided using embodiments of the disclosed automated interview system. As illustrated, alert data in alert window 706 may include, but is not limited to: a name of the manufacturer of the sensor, the type of alert (e.g., commercial fire), an elapsed time since receiving the alert, a time of day of the alert, a date of the alert, an address associated with the alert, a business name, a premises phone number, a first and last name of a point of contact, a zone or area within the premises for the alert, whether or not the alert was verified, the number of attempts used to verify the alarm, a verification summary, a service provider name, a monitoring center (a.k.a., a central station) phone number, and/or an operator number of the monitoring agency, according to an embodiment. Alert window 706 may also provide alert options 708 that enable, for example, a dispatcher to request dispatch or ignore the alert data.

FIG. 7B illustrates a diagram of an alert window 720, in accordance with aspects of the disclosure. Alert window 720 illustrates example alert data that may be received through an automated interview system and populated into an emergency response application by an EMS, according to embodiments of the disclosure. Alert options 708 may include dispatch options 722, and dispatch options 722 may include a request dispatch button 724 and an ignore alert button 726, for example. If a telecommunicator at an ESP selects request dispatch button 724, the telecommunicator may be connected (e.g., through a phone call) to emergency responders or the alert data may be transmitted to, for example,

FIG. 7C illustrates a diagram of an alert window 730, in accordance with aspects of the disclosure. Alert window 730 illustrates example alert data that may be received through an automated interview system and populated in piecemeal (e.g., as one or two parameters at a time) as parameters/categories of the alert data are inserted into or displayed in an emergency response application by an EMS, according to embodiments of the disclosure. In one embodiment, an alert ID and alert data is provided to emergency response application when two or more parameters are received from a central station telecommunicator, during the interview, instead of waiting for the automated interview to be completed. This “live” alert capture technique may enable the telecommunicator to begin dispatching an alert prior to receiving all parameters or information associated with an alert, according to an embodiment. Alert options 708 may include live alert options 732 and a refresh button 734, which may enable a telecommunicator to update or refresh alert window 730 any newly acquired alert data with the automated information system, for example.

FIG. 7D illustrates a diagram of an alert window 740, in accordance with aspects of the disclosure. Alert window 740 illustrates alert options 708 implemented as logging options 742. Logging options 742 may include a provide log button 744 and a request more information UI element 746. Provide log button 744 may be configured to cause the emergency response application to push responder notes or any responder actions taken to the ESP and then to a central station system even log, for example. Request more information UI element 746 may be a UI button or UI text box that may enable a telecommunicator to request more information from a central station. In response to selecting the request more information UI element 746, the ESP may be configured to call the relevant central station and use an IVR to audibly request more information for a particular alert ID. Once received, an ESP may provide the requested more information to the emergency response application and/or to a responder device, in accordance with various aspects of the disclosure.

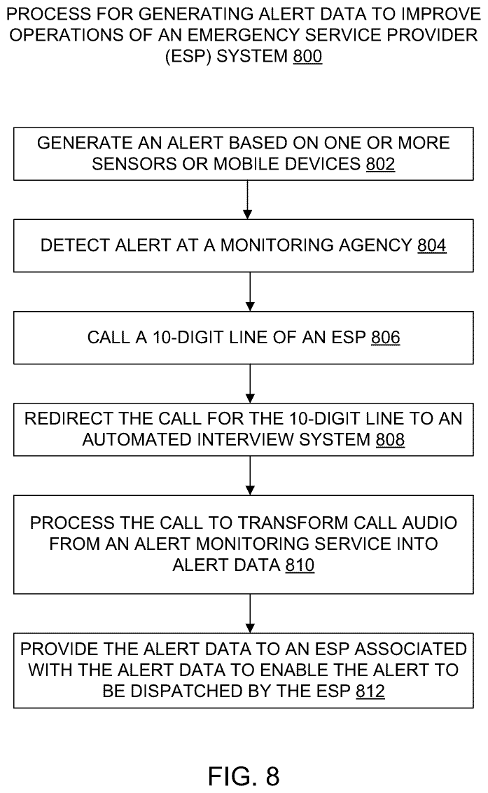

FIG. 8 illustrates a diagram of a process 800 for generating alert data to improve operations of an emergency service provider (ESP) system, in accordance with aspects of the disclosure. The order in which some or all of the process blocks appear in process 800 should not be deemed limiting. Rather, one of ordinary skill in the art having the benefit of the present disclosure will understand that some of the process blocks may be executed in a variety of orders not illustrated, or even in parallel.

At operation 802, process 800 includes generating an alert based on one or more sensors or mobile devices, according to an embodiment.

At operation 804, process 800 includes detecting an alert at a monitoring agency, according to an embodiment. A monitoring agency may also be referred to as a central station. Detecting an alert at a monitoring agency may include receiving and/or detecting the alert with a central station system. The alert is generated at a location that is remote to the monitoring agency, according to an embodiment.

At operation 806, process 800 includes calling a 10-digit line of an ESP, according to an embodiment. A telecommunicator of a monitoring agency may call the 10-digit line after receiving one or more sensor alerts and after attempting to verify the source of the alert.

At operation 808, process 800 includes redirecting the call for the 10-digit line to an automated interview system, according to an embodiment. Routing logic (e.g., telephony hardware and/or software) may be used at the ESP to redirect (e.g., using call forwarding) calls from the 10-digit line to an automated interview system of an emergency management system (EMS).

At operation 810, process 800 includes processing the call to transform call audio from an alert monitoring agency into alert data, according to an embodiment. Processing the call may be performed by one or more servers of an EMS. The interaction with the representative includes a number of interview prompts that are determined based on a prompt flow and/or the content of the response received from the representative, for example. Processing the call may include validating the address received and re-requesting the address if the address cannot be validated using, for example, commercially available address validation services/API.

At operation 812, process 800 includes providing (e.g., displaying) the alert data to an ESP associated with the alert data to enable the alert to be dispatched by the ESP (system), according to an embodiment. For example, the EMS may use the alert data to identify a particular ESP that is associated with the address provided during the interview and may forward the alert data to an emergency management application that is associated with the particular ESP. The emergency management application may be hosted by the EMS and accessed at the ESP using, for example, an Internet browser.

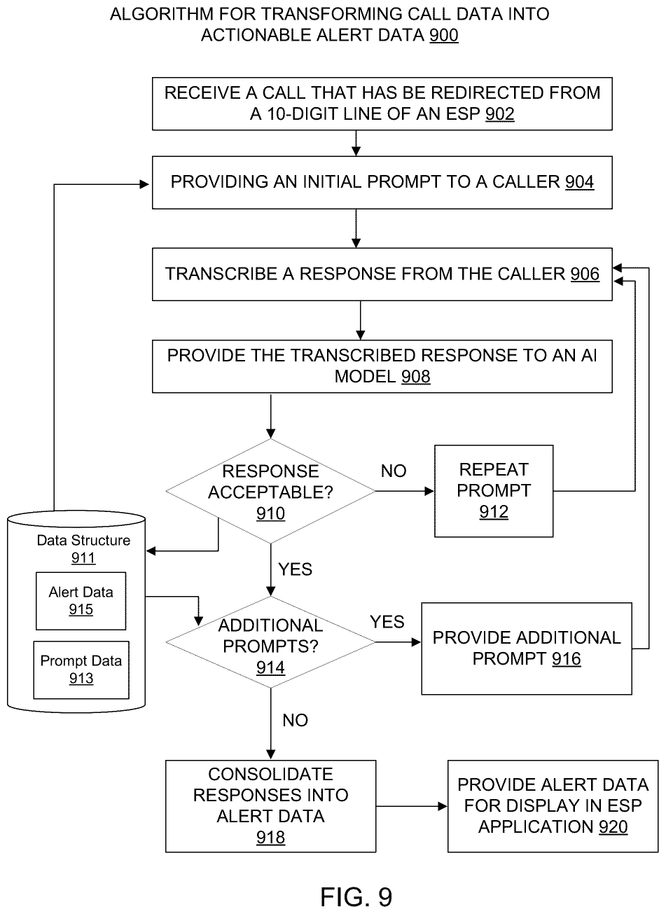

FIG. 9 illustrates a diagram of an algorithm 900 for transforming call audio into dispatchable alert data, in accordance with aspects of the disclosure. Algorithm 900 includes a number of operations that may be a process for transforming call audio into dispatchable alert data. Algorithm 900 may be implemented in an EMS (e.g., EMS 306 and/or 614) and/or automated interview system (e.g., automated interview system 352, 404, 472, 502, and/or 622), in accordance with various aspects of the disclosure. Algorithm 900 may include code that is implemented in interview logic that is executed by one or more processors or servers of an EMS, according to an embodiment. Algorithm 900 is an example process that may be performed or incorporated into interview logic of an automated interview system, as disclosed here. The order in which some or all of the operations appear in algorithm 900 should not be deemed limiting. Rather, one of ordinary skill in the art having the benefit of the present disclosure will understand that some of the process blocks may be executed in a variety of orders not illustrated, or even in parallel.

At operation 902, algorithm 900 includes receiving a call that has been directed from a 10-digit line of an ESP, according to an embodiment.

At operation 904, algorithm 900 includes providing an initial prompt to a caller, according to an embodiment. An example of an initial prompt may include, “What is the address associated with the alarm?” or “Please describe the alert you've received.” Operation 904 may include obtaining a prompt from prompt data 913 of data structure 911. Prompt data 913 may include a list of prompts and/or an order in which the prompts may be delivered. Data structure 911 may be configured to store and or associate prompt data 913 with alert data 915. Alert data 915 is data that is responsive to the prompts and is based on responses received from a central station operator to prompts.

At operation 906, algorithm 900 includes transcribing a response from the caller, according to an embodiment. Transcribing the response may include loading audio data into an AI model, according to an embodiment. Transcribing the response may include applying the audio data to a natural language processor to obtain a text version of the response.

At operation 908, algorithm 900 includes providing the transcribed response (e.g., response data) to an AI model, according to an embodiment. The transcribed response may be provided to an AI model with a prompt such as “Summarize the response.”, “Which category of alert does the response fall under.”, or “Summarize the caller's verification attempts.”, “Extract and address from the response.”, for example.

At operation 910, algorithm 900 includes determining if the response is acceptable, according to an embodiment. An acceptable response may be a response that includes a valid address, includes one of a number of predetermined alarm types, includes a verifiable telephone number, or the like. If the response is acceptable, the response may be appended (e.g., adding) to data structure 911 as alert data 915. In one embodiment, the output of the AI model is a summary that provides a summary or subject provided by the caller. If the response is unacceptable (e.g., deemed invalid, ambiguous, or unintelligible), operation 910 may proceed to operation 912. If the response is acceptable, operation 910 may proceed to operation 914.

At operation 912, algorithm 900 includes repeating a prompt, according to an embodiment. By repeating a prompt to the caller, algorithm 900 attempts to reacquire audio data that can be reprocessed in order to clarify one or more ambiguities or unverifiable information.

At operation 914, algorithm 900 includes determining whether there are additional prompts to provide to the caller, according to an embodiment. Whether additional prompts remain may be determined by a prompt list, a prompt flow, and/or an AI model-based prompt flow, according to an embodiment. The prompt list and/or prompt flow may be stored and/or selectively retrieved as prompt data 913 from data structure 911. Whether additional prompts exist may be based on whether the alert data is complete (e.g., necessary information has been obtained to enable emergency responders to respond). If additional prompts exist, operation 914 may proceed to operation 916. If additional prompts do not exist, operation 914 may proceed to operation 918.

At operation 916, algorithm 900 includes providing additional prompts, according to an embodiment.

At operation 918, algorithm 900 includes consolidating responses into alert data, according to an embodiment. The consolidated responses may be appended to data structure 911 to complete transforming call audio into alert data 915, according to an embodiment.

At operation 920, algorithm 900 includes providing alert data for display and/or dispatch with an emergency response application on an ESP system, according to an embodiment. For example, the alert data may be included or inserted into a queue of alerts and/or a queue of emergency calls being monitored and dispatched by staff of the ESP, according to an embodiment.

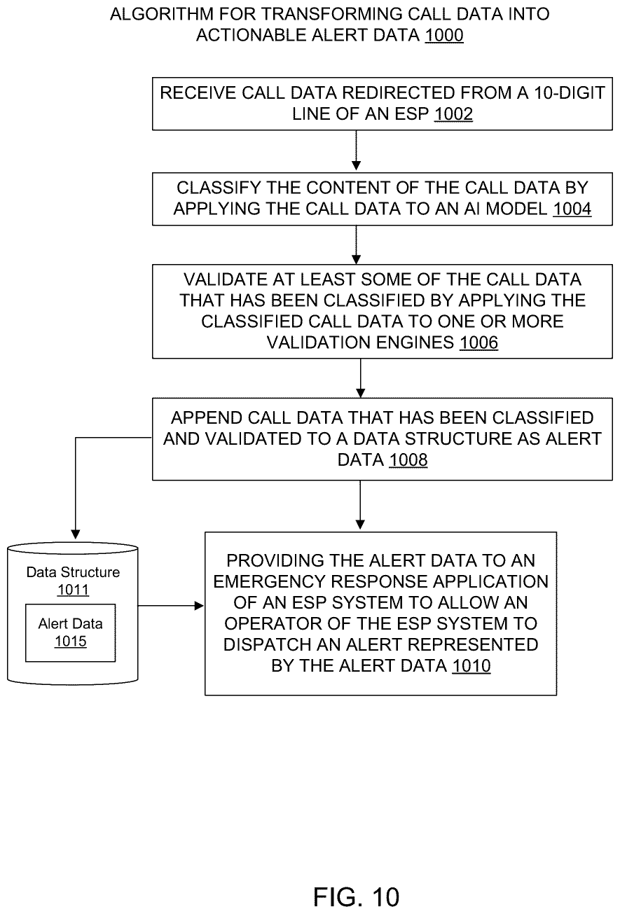

FIG. 10 illustrates a diagram of an algorithm 1000 for transforming audio data into dispatchable alert data, in accordance with aspects of the disclosure. Algorithm 1000 may be represented by a number of operations that form a process for transforming audio data. Algorithm 1000 may be implemented in an EMS (e.g., EMS 306 and/or 614) and/or automated interview system (e.g., automated interview system 352, 404, 472, 502, and/or 622), in accordance with various aspects of the disclosure. Algorithm 1000 may include code that is implemented in interview logic that is executed by one or more processors or servers of an EMS, according to an embodiment. Algorithm 1000 is an example process that may be performed or incorporated into interview logic of an automated interview system, as disclosed here. The order in which some or all of the operations appear in algorithm 1000 should not be deemed limiting. Rather, one of ordinary skill in the art having the benefit of the present disclosure will understand that some of the process blocks may be executed in a variety of orders not illustrated, or even in parallel.

At operation 1002, algorithm 1000 includes receiving call data redirected from a 10-digit (e.g., non-emergency) line, according to an embodiment. Call data may be audio call data that is recorded into 3-10 second segments. Operation 1002 proceeds to operation 1004, according to an embodiment.

At operation 1004, algorithm 1000 includes classifying the content of the call data by applying the call data to an AI model, according to an embodiment. Classifying the content of the call data may include identifying the nature of the alert, extracting or identifying an address from the call data, determining a summary of verification steps taken, identifying a business name, or the like. Operation 1004 proceeds to operation 1006, according to an embodiment.

At operation 1006, algorithm 1000 includes validating at least some of the call data that has been classified, by applying the applying the classified call data to one or more validation engines, according to an embodiment. Operation 1006 proceeds to operation 1008, according to an embodiment.

At operation 1008, algorithm 1000 includes appending call data that has been classified and validated to a data structure (e.g., data structure 1011) as alert data (e.g., alert data 1015), according to an embodiment. Operation 1008 proceeds to operation 10010, according to an embodiment.

At operation 1010, algorithm 1000 includes providing the alert data to an emergency response application of an ESP system to allow an operator of the ESP system to dispatch an alert represented by the alert data, according to an embodiment. To provide the alert data, the alert data may be read from or sent as data structure 1011.

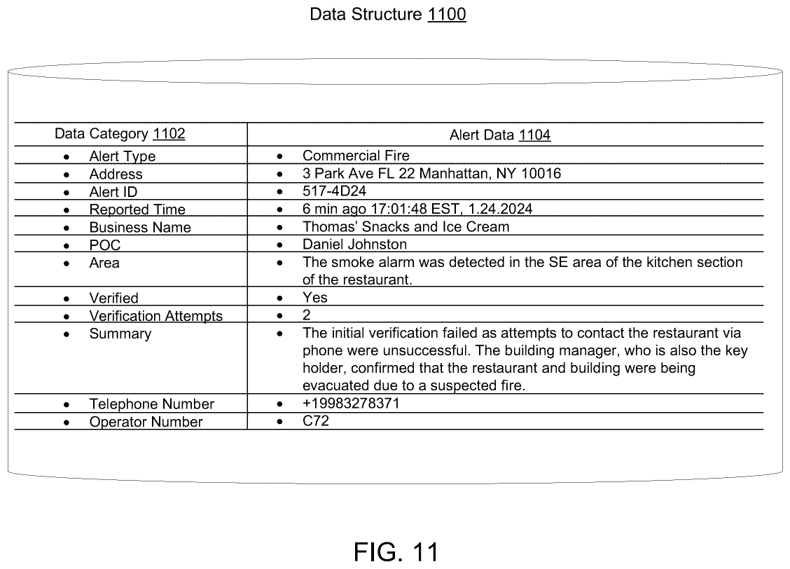

FIG. 11 illustrates a diagram of a data structure 1100 for alert data in an emergency management system, in accordance with embodiments of the disclosure. Data structure 1100 may be implemented as a table, an array, a database, or other logical data structure. Data structure 1100 may include a number of data categories 1102 that are associated with corresponding alert data 1104 that are generated from audio call data and/or response data.

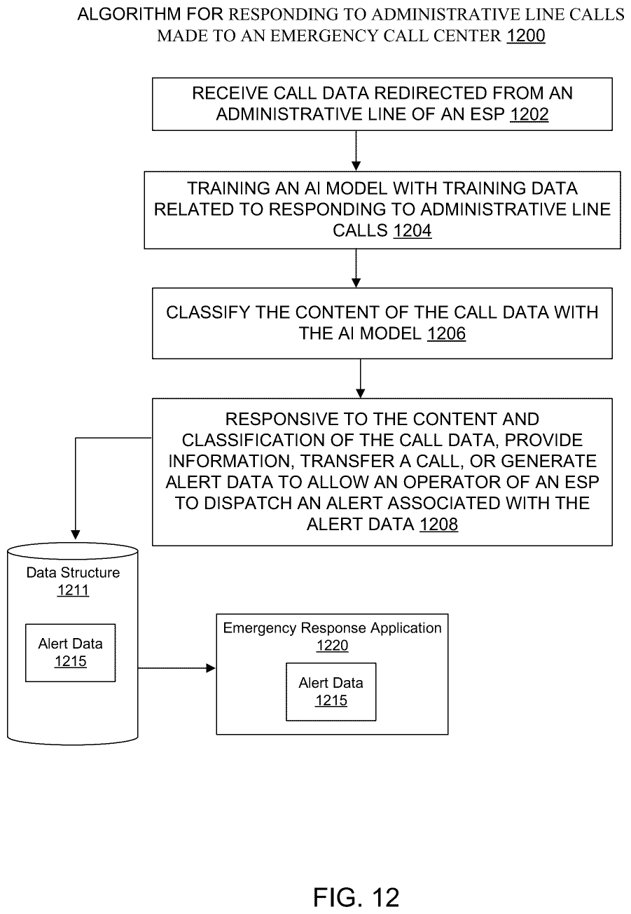

FIG. 12 illustrates a flow diagram of an algorithm 1200 for responding to administrative line calls made to an emergency call center, in accordance with embodiments of the disclosure. Algorithm 1200 may be represented by a number of operations that form a process for transforming audio data. Algorithm 1200 may be implemented in an EMS (e.g., EMS 306 and/or 614) and/or automated interview system (e.g., automated interview system 352, 404, 472, 502, and/or 622), in accordance with various aspects of the disclosure. Algorithm 1200 may include code that is implemented in interview logic that is executed by one or more processors or servers of an EMS, according to an embodiment. Algorithm 1200 is an example process that may be performed or incorporated into interview logic of an automated interview system, as disclosed here. The order in which some or all of the operations appear in algorithm 1200 should not be deemed limiting. Rather, one of ordinary skill in the art having the benefit of the present disclosure will understand that some of the process blocks may be executed in a variety of orders not illustrated, or even in parallel.

At operation 1202, algorithm 1200 includes receiving call data that is redirected from an administrative line of an ESP, according to an embodiment. Call forwarding may be used to redirect call data to the EMS, for example. Operation 1202 proceeds to operation 1204, according to an embodiment.

At operation 1204, algorithm 1200 includes training an AI model with training data related to responding to administrative line calls, according to an embodiment. Operation 1204 proceeds to operation 1206, according to an embodiment.

At operation 1206, algorithm 1200 includes classifying the content of the call data with the AI model, according to an embodiment. Operation 1206 proceeds to operation 1208, according to an embodiment.

At operation 1208, algorithm 1200 includes, responsive to the content and classification of the call data, providing information, transferring a call, or generating alert data to allow an operator (e.g., dispatcher) of an ESP to dispatch an alert associated with the alert data, according to an embodiment. The alert data (e.g., alert data 1215) may be stored in a data structure 1211, which may be provided to an emergency response application 1220 to enable dispatching of the alert.

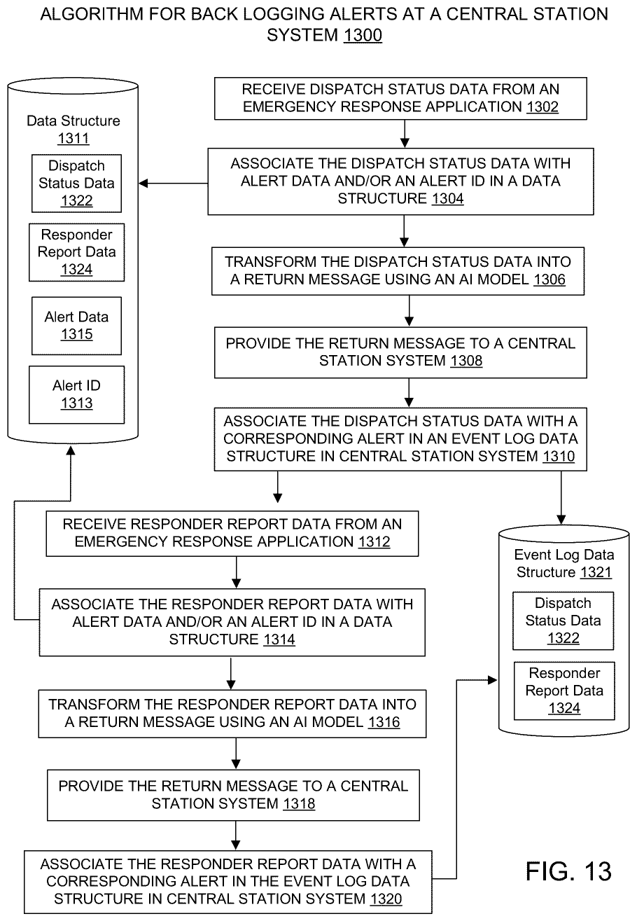

FIG. 13 illustrates a flow diagram of an algorithm for back logging alerts at a monitoring agency, in accordance with embodiments of the disclosure. Algorithm 1300 may be represented by a number of operations that form a process for transforming audio data. Algorithm 1300 may be implemented in an EMS (e.g., EMS 306 and/or 614) and/or automated interview system (e.g., automated interview system 352, 404, 472, 502, and/or 622), in accordance with various aspects of the disclosure. Algorithm 1300 may include code that is implemented in interview logic that is executed by one or more processors or servers of an EMS, according to an embodiment. Algorithm 1300 is an example process that may be performed or incorporated into interview logic of an automated interview system, as disclosed here. The order in which some or all of the operations appear in algorithm 1300 should not be deemed limiting. Rather, one of ordinary skill in the art having the benefit of the present disclosure will understand that some of the process blocks may be executed in a variety of orders not illustrated, or even in parallel.

At operation 1302, algorithm 1300 includes receiving dispatch status data from an emergency response application (e.g., used by an ESP operator), according to an embodiment. Operation 1302 proceeds to operation 1304, according to an embodiment.

At operation 1304, algorithm 1300 includes associating the dispatch status data (e.g., dispatch status data 1322) with alert data (e.g., alert data 1315) and/or an alert ID (e.g., alert ID 1313) in a data structure (e.g., data structure 1311), according to an embodiment. Operation 1304 proceeds to operation 1306, according to an embodiment.

At operation 1306, algorithm 1300 includes transforming the dispatch status data into a return message using an AI model, according to an embodiment. Operation 1306 proceeds to operation 1308, according to an embodiment.

At operation 1308, algorithm 1300 includes providing the return message to a central station system, according to an embodiment. The return message may be returned via email, text message (e.g., SMS), or by using an automated interview system to call a central station and use IVR to audibly provide the return message. Operation 1308 proceeds to operation 1310, according to an embodiment.

At operation 1310, algorithm 1300 includes associating the dispatch status data (e.g., dispatch status data 1322) with a corresponding alert in an event log data structure (e.g., event log data structure 1321) that is stored and/or managed by a central station system, according to an embodiment. Operation 1310 proceeds to operation 1312, according to an embodiment.

At operation 1312, algorithm 1300 includes receiving responder report data from an emergency response application, according to an embodiment. Operation 1312 proceeds to operation 1314, according to an embodiment.

At operation 1314, algorithm 1300 includes associating the responder report data with alert data and/or an alert ID in a data structure (e.g., data structure 1311), according to an embodiment. Operation 1314 proceeds to operation 1316, according to an embodiment.

At operation 1316, algorithm 1300 includes transforming the responder report data into a return message using an AI model, according to an embodiment. Operation 1316 proceeds to operation 1318, according to an embodiment.

At operation 1318, algorithm 1300 includes providing the return message to the central station system, according to an embodiment. Operation 1318 proceeds to operation 1320, according to an embodiment.

At operation 1320, algorithm 1300 includes associating the responder report data with a corresponding alert in the event log data structure (e.g., event log data structure 1321) in the central station system, according to an embodiment.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method of generating alert data from alarm-reporting telephone calls made to an emergency service provider (ESP), comprising:
receiving, with a server, call data that is directed to an ESP from a central station and that is redirected to the server from the ESP;
categorizing content of the call data by applying the call data to an artificial intelligence (AI) model with one or more AI model prompts, wherein categories of the content includes an address and an alert type;
validating the address by sending the address to an address validation service;
appending the address and the alert type to a data structure, wherein the address and alert type are alert data;
associating the alert data with an alert identifier (ID) in the data structure; and
providing the alert data to an emergency response application to allow a dispatcher at the ESP to dispatch emergency responders based on the alert data.

2. The method of claim 1, further comprising:
maintaining a plurality of prompts, wherein each of the plurality of prompts corresponds with at least one of the categories; and
providing each of the plurality of prompts to the central station with an interactive voice response (IVR) system to align the content of the call data with the categories.

3. The method of claim 2, further comprising:
providing the alert data to the ESP while the categories of the alert data are incomplete; and
continuing to provide the ones of the plurality of prompts to receive responses in the call data that are responsive to the categories of the alert data that are incomplete.

4. The method of claim 2, further comprising:
completing the alert data with each of the categories, prior to providing the alert data to the ESP.

5. The method of claim 1, further comprising:
training the AI model to support one or more particular types of ESP, wherein the one or more particular types of ESP include: a 9-1-1 call center, a railway call center, or an alarm monitoring central station.

6. The method of claim 5, wherein training the AI model to support the one or more particular types of ESP includes training the AI model with questions, answers, training manuals, lessons learned, case studies, and historical data associated with the one or more particular types of ESP.

7. The method of claim 1, further comprising:
displaying the alert data in a first user interface queue in the emergency response application, wherein the alert data is representative of call to a non-emergency number at the ESP; and
displaying emergency call data a second user interface queue in the emergency response application, wherein the emergency call data is representative of calls to an emergency number at the ESP.

8. The method of claim 1, further comprising:
receiving, with the server, a request for additional information from central station, where the request is submitted to the emergency response application;
converting the request for additional information into an audio request for more information using an IVR system;
providing the audio request for additional information to the central station;
receiving a response to the audio request from the central station;
associating the response with the alert ID in the data structure; and
updating the alert data in the emergency response application with the response to the audio request for additional information.

9. The method of claim 1, further comprising:
receiving supplemental mobile device information from a third-party server; and
providing the supplemental mobile device information to the emergency response application to supplement primary mobile device information displayed by the emergency response application.

10. The method of claim 1, further comprising:
receiving, with the server, an alert report from the emergency response application, wherein the emergency response application receives the alert report from an emergency responder for a particular alert; and
providing the alert report the central station to allow the central station to a status of the particular alert based on the alert report.

11. An alert system, comprising:
a central station system having an alert response application to receive and display notifications from a plurality of sensors, wherein the central station system includes first call handling equipment (CHE);
an emergency service provider (ESP) system having second CHE operable to receive calls to an emergency call telephone number and calls to an alarm-reporting telephone number, wherein the ESP system includes an emergency response application having a graphical user interface (GUI) to display a queue of alerts, wherein each of the alerts includes alert data that is displayable from in the GUI of the emergency response application; and
an emergency management system (EMS) communicatively coupled to the ESP system and operable to populate at least part of the queue of alerts with the alert data, wherein the EMS includes an automated interview system operable to receive calls made from the first CHE to the second CHE on the alarm-reporting telephone number, wherein the automated interview system is operable to provide prompts and receive responses in an interview of a central station telecommunicator, wherein the automated interview system is operable to convert the responses into the alert data, wherein the EMS includes a data structure that associates the alert data with an alert ID, wherein the EMS provides the alert data to the emergency response application of the ESP system.

12. The alert system of claim 11, wherein the second CHE includes routing logic configured to forward calls made to the alarm reporting telephone number, wherein the routing logic forwards the calls to the EMS.

13. The alert system of claim 11, wherein the automated interview system includes an artificial intelligence (AI) model, wherein the automated interview system applies at least some of the responses to the AI model to associate content of the responses with one or more categories for the alert data, wherein the one or more categories include at least one of an address, an alert type, a summary, a point of contact name, or a number of verification attempts.

14. The alert system of claim 11, wherein the automated interview system includes an AI model, wherein the automated interview system applies at least some of the responses to the AI model determine a subsequent prompt to provide in the interview, wherein the subsequent prompt is selected from a plurality of predetermined prompts for the interview.

15. The alert system of claim 11, wherein the automated interview system accesses an address validation service to validate an address included in at least one of the responses, wherein the automated interview system provides the at least one of the response to an AI model to extract the address from the at least one of the responses.

16. The alert system of claim 11, wherein the emergency response application is operable to receive an alert report from an emergency responder for a particular alert in the queue of alerts, wherein the emergency response application is operable to provide the alert report to the EMS, wherein the automated interview system is operable to provide the alert report to the first CHE of the central station system through a call back to the first CHE, wherein the central station system determines an alert turn-around time metric based on the alert report.

17. A method of handling telephone calls made to an emergency service provider (ESP), comprising:
receiving, with a server of an emergency management system (EMS), call data during a telephone call made to call handling equipment (CHE) for an emergency service provider (ESP);
providing prompts with an interactive voice response (IVR) system during the telephone call, wherein an order of the prompts is at least partially determined using an artificial intelligence (AI) model;
receiving responses to the prompts in the call data;
providing at least some of the responses to the prompts in the call data to the AI model to characterize content of the at least some of the responses;
based on the content, performing at least one of:
provide information to answer a question;
transfer the telephone call to another telephone number; or
generate and provide an alert to an emergency response application at the ESP; and
terminating the telephone call.

18. The method of claim 17, wherein the telephone number is an administrative line for the ESP, wherein the ESP is a Public Safety Answering Point (PSAP), wherein the telephone number is a first telephone number, wherein the CHE is configured to receive a second telephone number and a third telephone number, wherein the second telephone number is an emergency telephone number and the third telephone number is an alarm-reporting telephone number.

19. The method of claim 17, further comprising:
training the AI model with context-specific training data, wherein the context-specific training data includes: pre-determined questions, pre-determined responses, training manuals, or historical incidents reported to the ESP.

20. The method of claim 17, further comprising:
searching for caller context data based on a location of a caller;
receiving caller context data; and
applying the caller context data to the AI model with the responses to at least partially prioritize the order of the prompts based on the caller context data, wherein the caller context data includes two or more of: current traffic conditions at the location of the caller, a time of day of the telephone call, or weather conditions for the location of the caller.

21. A method of handling alarm reporting telephone calls made to an emergency service provider (ESP), comprising:
redirecting a call to an ESP from a central station, to an emergency management system (EMS) server;
generating response transcripts from a plurality of interactive voice response (IVR) prompt responses;
analyzing the response transcripts by an artificial intelligence (AI) model to extract an address and an alert type from the response transcripts;
determining that the address is not valid;
sending a new prompt requesting a different address; and
providing an alert to the ESP, comprising the different address, where the different address is a dispatchable address.
